(19) United States
(12) Patent Application Publication
(10) Pub. No.: US 2008/0229247 A1
(43) Pub. Date: Sep. 18, 2008

(54) APPARATUS, METHOD, AND COMPUTER PROGRAM PRODUCT FOR PROCESSING DISPLAY

(76) Inventor: Akiko Bamba, Tokyo (JP)

Correspondence Address: DICKSTEIN SHAPIRO LLP, 1825 EYE STREET NW, Washington, DC, 20006-5403, US

(21) Appl. No.: 12/046,116

(22) Filed: Mar. 11, 2008

(30) Foreign Application Priority Data
Mar. 14, 2007 (JP) 2007-065691

(51) Int. Cl. G06F 3/048

(52) U.S. Cl. 715/835

(57) ABSTRACT

A display processing unit displays on a display unit a multi-processing symbol including a first processing symbol and a second processing symbol, which is for giving a selection instruction to perform a first process and a second process simultaneously or in a row. An input receiving unit receives a selection input of the multi-processing symbol from a user. When the multi-processing symbol is received, an execution controller performs simultaneously or in a row the first process corresponding to the first processing symbol and the second process corresponding to the second processing symbol.

### CROSS-REFERENCE TO RELATED APPLICATIONS

The present application claims priority to and incorporates by reference the entire contents of Japanese priority document 2007-065691 filed in Japan on Mar. 14, 2007.

### BACKGROUND OF THE INVENTION

1. Field of the Invention

The present invention relates to an apparatus, a method, and a computer program product for processing a display of icons for executing various functions.

2. Description of the Related Art

Recently, when various functions installed in an image forming apparatus or the like are executed, symbols such as icons indicating processing contents of various functions are displayed on an operation display unit, such as a liquid crystal display (LCD) touch panel, thereby enabling a user to ascertain the processing contents of functions intuitively and easily execute the function of the image forming apparatus by inputting selection of any icon. Further, a technique has been disclosed, by which a user can intuitively recognize the presence of setting of printing attributes (output destination, printing conditions, and the like) and the content thereof for each document, for example, when document icons are displayed on a list (see, for example, Japanese Patent Application Laid-open No. 2000-137589).

In the recent image forming apparatuses, however, there is a plurality of functions, and there are many items to be set. Therefore, when the processing of functions is performed simultaneously or in a row, selection input of a plurality of icons respectively corresponding to the processing functions needs to be performed, thereby making a selecting operation of the icon complicated. Further, when the processing of functions is performed simultaneously or in a row, selection of icons of respective functions is input by a user, while ascertaining a plurality of processing contents. Therefore, it is difficult to ascertain and operate the processing contents simultaneously, and this difficulty can cause an operational error. Also, when continuous processing is performed by performing a plurality of processes by a plurality of different apparatuses, the functions of respective apparatuses need to be ascertained to perform the processing, thereby making the operation more complicated and causing an operational error.

### SUMMARY OF THE INVENTION

It is an object of the present invention to at least partially solve the problems in the conventional technology.

According to an aspect of the present invention, there is provided an apparatus for processing a display, including a display processing unit that displays on a display unit a multi-processing symbol including a first processing symbol corresponding to a first process and a second processing symbol corresponding to a second process that is different from the first process from among a plurality of processes, the multi-processing symbol for giving a selection instruction to perform the first process and the second process simultaneously or in a row; an input receiving unit that receives a selection input of the multi-processing symbol from a user; and an execution controller that performs, upon reception of the multi-processing symbol by the input receiving unit, simultaneously or in a row the first process corresponding to the first processing symbol included in a received multi-processing symbol and the second process corresponding to the second processing symbol included in the received multi-processing symbol.

Furthermore, according to another aspect of the present invention, there is provided a method of processing a display, including displaying on a display unit a multi-processing symbol including a first processing symbol corresponding to a first process and a second processing symbol corresponding to a second process that is different from the first process from among a plurality of processes, the multi-processing symbol for giving a selection instruction to perform the first process and the second process simultaneously or in a row; receiving a selection input of the multi-processing symbol from a user; and performing, upon reception of the multi-processing symbol at the receiving, simultaneously or in a row the first process corresponding to the first processing symbol included in a received multi-processing symbol and the second process corresponding to the second processing symbol included in the received multi-processing symbol.

Moreover, according to still another aspect of the present invention, there is provided a computer program product comprising a computer-usable medium having computer-readable program codes embodied in the medium that when executed cause a computer to execute displaying on a display unit a multi-processing symbol including a first processing symbol corresponding to a first process and a second processing symbol corresponding to a second process that is different from the first process from among a plurality of processes, the multi-processing symbol for giving a selection instruction to perform the first process and the second process simultaneously or in a row; receiving a selection input of the multi-processing symbol from a user; and performing, upon reception of the multi-processing symbol at the receiving, simultaneously or in a row the first process corresponding to the first processing symbol included in a received multi-processing symbol and the second process corresponding to the second processing symbol included in the received multi-processing symbol.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a functional block diagram of a multifunction peripheral (MFP) according to a first embodiment of the present invention;

FIG. 2 is a data structure diagram of one example of a process correspondence table in the first embodiment;

FIG. 3 is one example of an operation panel of the MFP;

FIG. 4 is a schematic diagram of one example of an initial menu screen;

FIG. 5 is a schematic diagram for explaining one example of a configuration of a multi-processing icon;

FIG. 6 is a flowchart of an overall flow of a display process in the first embodiment;

FIG. 7 is a flowchart of an overall flow of a multi-processing-icon generating process in the first embodiment;

FIG. 8 is a schematic diagram for explaining a multi-processing-icon generating process;

FIGS. 9 to 21 are schematic diagrams for explaining another example of a configuration of a multi-processing icon;

FIG. 22 is a schematic diagram for explaining an outline of processes to be performed by a mobile phone and an MFP according to a second embodiment of the present invention;

FIG. 23 is a functional block diagram of the mobile phone according to the second embodiment;

FIG. 24 is a schematic diagram for explaining one example of a configuration of a multi-processing icon displayed on the mobile phone;

FIG. 25 is a schematic diagram for explaining another example of the configuration of the multi-processing icon for display to be displayed on the MFP;

FIG. 26 is a schematic diagram for explaining still another example of the configuration of the multi-processing icon for display to be displayed on the MFP;

FIG. 27 is a flowchart of an overall flow of a display executing process in the second embodiment;

FIG. 28 is a schematic diagram for explaining an outline of a process performed by a digital camera, a personal computer (PC), a projector, and the like according to a third embodiment of the present invention;

FIG. 29 is a functional block diagram of the digital camera according to the third embodiment;

FIG. 30 is a schematic diagram for explaining one example of the configuration of a multi-processing icon displayed on the digital camera;

FIGS. 31 and 32 are schematic diagrams for explaining another example of the configuration of the multi-processing icon displayed on the digital camera;

FIG. 33 is a functional block diagram of the PC according to the third embodiment;

FIGS. 34 to 36 are flowcharts of an overall flow of a display executing process in the third embodiment;

FIGS. 37 to 39 are schematic diagrams for explaining an outline of a process performed by a PC, a car navigation system, a mobile phone, or the like according to a fourth embodiment of the present invention;

FIG. 40 is a functional block diagram of the PC according to the fourth embodiment;

FIG. 41 is a schematic diagram for explaining one example of the configuration of the multi-processing icon displayed on a monitor of the PC;

FIG. 42 is a functional block diagram of a car navigation system according to the fourth embodiment;

FIG. 43 is a schematic diagram for explaining one example of the configuration of the multi-processing icon displayed on the car navigation system;

FIG. 44 is a functional block diagram of the mobile phone according to the fourth embodiment;

FIGS. 45 to 47 are schematic diagrams for explaining one example of the configuration of the multi-processing icon displayed on the mobile phone;

FIG. 48 is a flowchart of an overall flow of a display executing process in the fourth embodiment;

FIG. 49 is a flowchart of an overall flow of another display executing process in the fourth embodiment;

FIG. 50 is a flowchart of an overall flow of still another display executing process in the fourth embodiment;

FIG. 51 is a schematic diagram for explaining an outline of a process performed by an MFP, an in-vehicle MFP, and a car navigation system according to a fifth embodiment of the present invention;

FIG. 52 is a schematic diagram for explaining one example of a multi-processing icon displayed on the MFP;

FIG. 53 is a schematic diagram for explaining another example of the multi-processing icon displayed on the MFP;

FIG. 54 is a schematic diagram for explaining one example of the configuration of a multi-processing icon displayed on the in-vehicle MFP;

FIGS. 55 to 57 are flowcharts of an overall flow of a display executing process in the fifth embodiment;

FIG. 58 is a block diagram of a hardware configuration common to the MFPs according to the first embodiment and the second embodiments and the in-vehicle MFP according to the fifth embodiment; and

FIG. 59 depicts a hardware configuration of a PC according to the third and fourth embodiments.

### DETAILED DESCRIPTION OF THE PREFERRED EMBODIMENTS

Exemplary embodiments of an apparatus, a method, and a computer program product for processing a display according to the present invention will be described below in detail with reference to the accompanying drawings.

A display processing apparatus according to a first embodiment of the present invention displays a multi-processing icon in which a plurality of processing icons respectively corresponding to a plurality of processes of respective functions are located, and receives a selection input of the multi-processing icon, thereby performing the processes simultaneously or in a row. In the first embodiment, a case where the display processing apparatus is applied to a multifunction peripheral (MFP) that includes a plurality of functions of a copying machine, a fax machine, and a printer in one housing is explained.

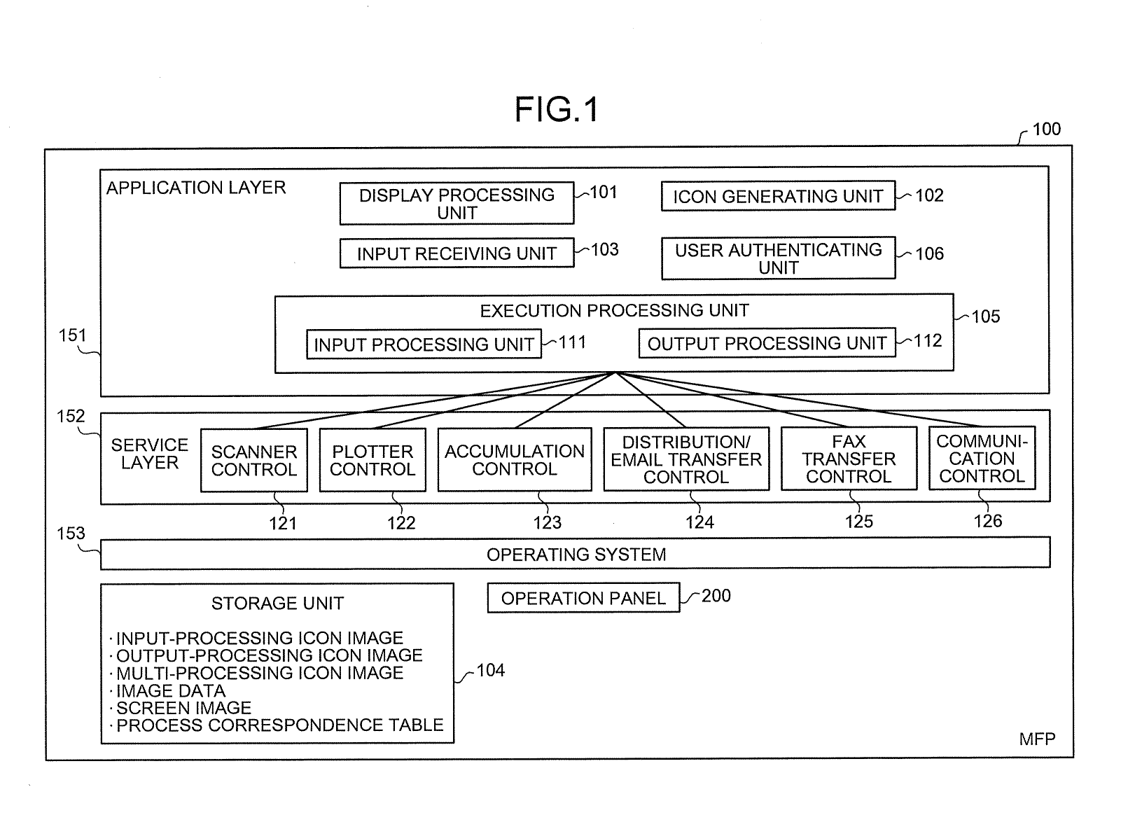

FIG. 1 is a functional block diagram of an MFP 100 according to the first embodiment. As shown in FIG. 1, the MFP 100 includes an operating system 153, a service layer 152, an application layer 151, a storage unit 104, and an operation panel 200 as a configuration.

As shown in FIG. 1, the functions of the MFP 100 have a hierarchical relationship such that the service layer 152 is established above the operating system 153, and the application layer 151 including a characteristic part of the first embodiment described later is established above the service layer 152.

The operating system 153 manages resources of the MFP 100 including hardware resources, and provides functions utilizing the resources with respect to the service layer 152 and the application layer 151.

The service layer 152 corresponds to a driver that controls the hardware resource included in the MFP 100. The service layer 152 controls the hardware resources included in the MFP 100 such as a scanner control 121, a plotter control 122, an accumulation control 123, a distribution/email transfer control 124, a FAX transfer control 125, and a communication control 126 in response to an output request from an execution processing unit 105 in the application layer 151 described later to execute various functions.

The storage unit 104 stores image data read from a paper document, received via an email, or received by a FAX, screen images such as a screen for performing various settings, and the like. The storage unit 104 stores respective icon images such as an image of an input icon, an image of an output icon, and an image of a multi-processing icon as an image to be displayed on the operation panel 200 (described later).

The icon in this context means an icon that displays various data or processing functions as pictures or pictographs on a displayed screen, and the icon is a concept of a symbol that has a broad concept including an image. The multi-processing includes the input process and the output process with respect to the apparatus (MFP), and the processing icon represents an icon for giving a selection instruction of processes by respective functions, corresponding to each of the multi-processing (input process and output process) by the respective functions of the apparatus (MFP). The multi-processing icon includes a plurality of processing icons, and when it is selected, performs the processes corresponding to each of the processing icons simultaneously or in a row. In the first embodiment, the icon is displayed on the screen. However, the one displayed on the screen is not limited to the icon, and symbols indicating various data or processing functions in a sign, a character string, or an image, other than the icon, can be displayed.

The input icon, which is one of the processing icons, corresponds to an input process such as scanning among the functions of the MFP 100. The output icon, which is one of the processing icons, corresponds to an output process such as printing among the functions of the MFP 100. The multi-processing icon in the first embodiment includes an image of the input icon and an image of the output icon, and when the multi-processing icon is selected and instructed by a user, performs a plurality of processes corresponding to the input icon and the output icon constituting the multi-processing icon simultaneously or in a row.

The storage unit 104 stores a process correspondence table in which a key event and icon name as icon identification information specific to the icon such as the multi-processing icon, the input icon, and the output icon, a processing content as process identification information of the respective icons such as the multi-processing, the input process, and the output process performed simultaneously or in a row, and the icon image are registered in association with each other.

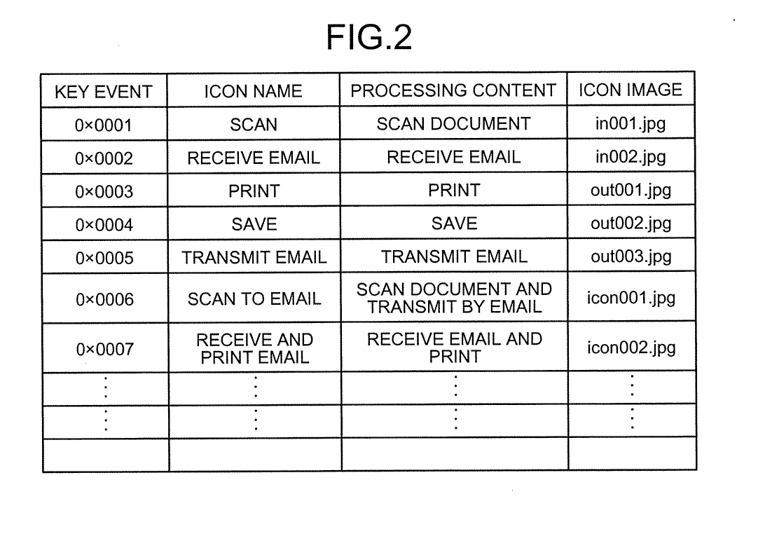

The process correspondence table is explained below in detail. FIG. 2 is a data structure diagram of one example of a process correspondence table in the first embodiment. As shown in FIG. 2, the process correspondence table registers key events “0x0001”, “0x0002”, and the like, which is the icon identification information specific to the multi-processing icon and respective processing icons, icon names “scan”, “print”, “scan to email”, and the like as the icon identification information, processing content “scan document”, “print”, or “scan document and transmit by email”, which is process identification information of the respective processing icons such as the multi-processing, the input process, and the output process to be performed simultaneously or in a row, and icon images “in 001.jpg”, “out001.jpg”, “icon001.jpg” in association with each other.

In the example shown in FIG. 2, an example in which the name of the processing content is registered is shown as the processing content for easy understanding, and specifically, program names for executing the respective processing contents are registered. That is, each program name is registered, for example, scanning program for “scan document” and printing program for “print”. Further, for “scan document and transmit by email”, which is the processing content registered in the multi-processing icons, two program names of scanning program and email transmission program are registered.

The storage unit 104 can store data such as the image data, and can be formed of any generally used storage medium such as a hard disk drive (HDD), an optical disk, and a memory card.

The operation panel 200 is a user interface that displays a selection screen and receives an input on the selection screen.

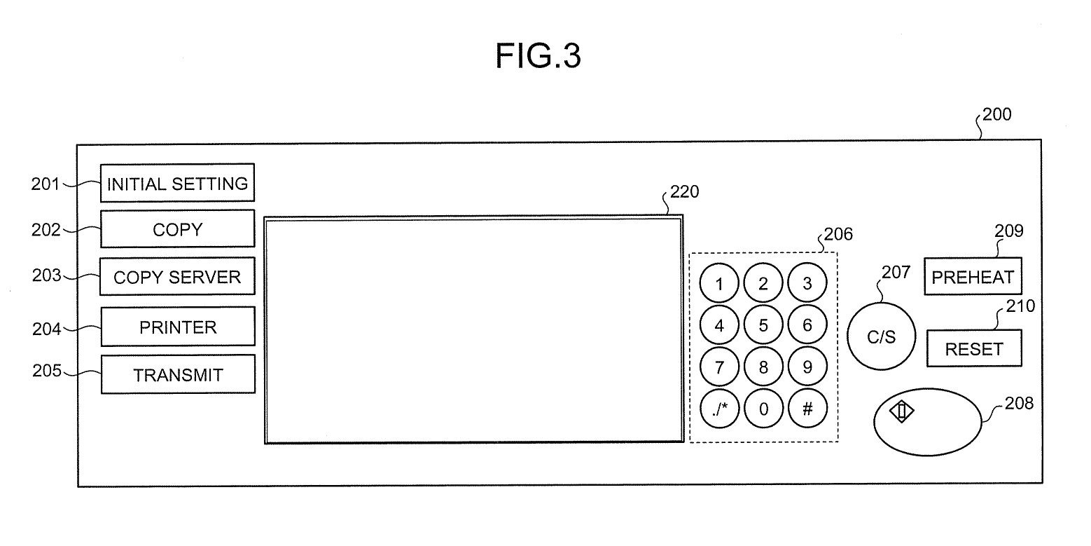

FIG. 3 is one example of the operation panel of the MFP. As shown in FIG. 3, the operation panel 200 includes an initial setting key 201, a copy key 202, a copy server key 203, a printer key 204, a transmission key 205, a ten key 206, a clear/stop key 207, a start key 208, a preheat key 209, a reset key 210, and an LCD touch panel 220. The multi-processing icon, which is a characteristic of the first embodiment, is displayed on an initial menu screen or the like of the LCD touch panel 220. The screen is explained later. A central processing unit (CPU) that controls display of various screens on the LCD touch panel 220 and key input from respective keys or the LCD touch panel 220 is equipped in the operation panel 200, separately from a CPU in the body of the MFP. Because the CPU in the operation panel 200 only controls screen display or key input, the CPU has a lower performance than that of the CPU in the body of the MFP.

While the MFP 100 also includes various hardware resources such as a scanner and a plotter other than the storage unit 104 and the operation panel 20, explanations thereof will be omitted.

Returning to FIG. 1, the application layer 151 includes a display processing unit 101, an icon generating unit 102, an input receiving unit 103, the execution processing unit 105, and a user authenticating unit 106.

The user authenticating unit 106 authenticates a user when the user uses the MFP 100. As a method of authentication, any authentication method can be used, regardless of whether the method is well known to a person skilled in the art. When the user authentication is successful by the user authenticating unit 106, the MFP 100 permits the user to use a predetermined function. The permitted function includes, for example, transfer of emails. The user authentication by the user authenticating unit 106 is performed first, and the processes described later are to be performed, it is assumed basically that the user authentication has finished.

The display processing unit 101 displays the initial menu screen (described later) for setting the MFP on the LCD touch panel 220, to display the input icon and the output icon on the initial menu screen. Further, the display processing unit 101 displays the initial menu screen on the LCD touch panel 220, to display the multi-processing icon including the input icon and the output icon, among the processes including the input process and the output process, for giving a selection instruction to perform the input process corresponding to the input icon and the output process corresponding to the output icon simultaneously or in a row, on the initial menu screen.

The display processing unit 101 can also display the multi-processing icon including the input icon, the output icon, and one or a plurality of input icons or output icons, among the processes including the input process and the output process, for giving a selection instruction to perform the three or more input and output processes simultaneously or in a row, on the initial menu screen displayed on the LCD touch panel 220.

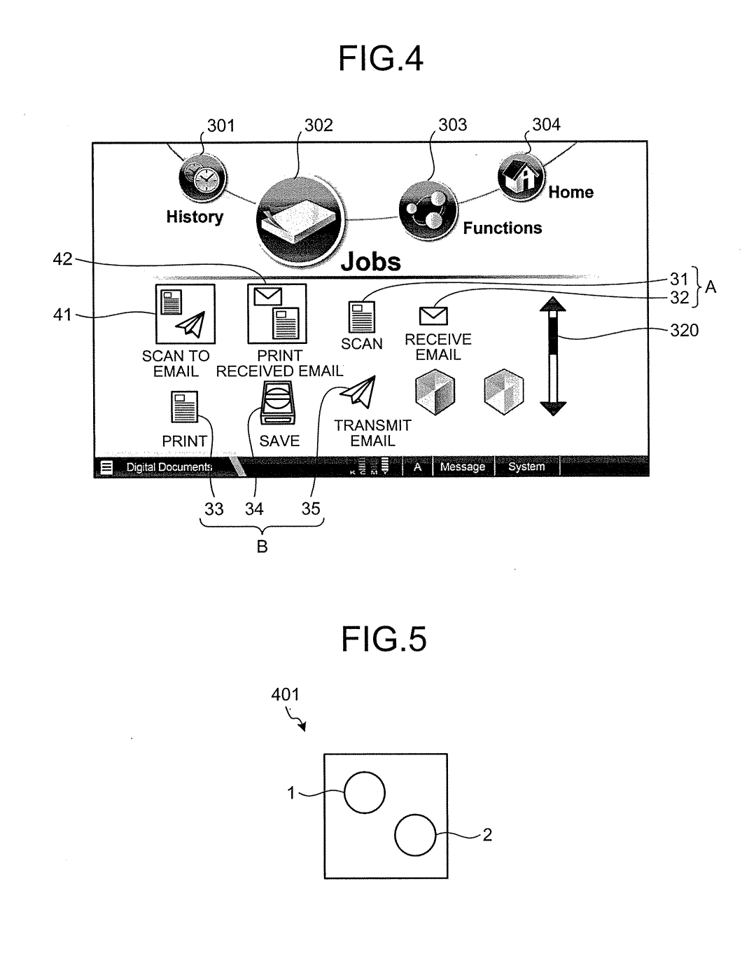

FIG. 4 is a schematic diagram of one example of the initial menu screen. The initial menu screen is a screen displayed by the display processing unit 101, and is a selection screen on which the icon for selecting and instructing a function to be executed by the MFP 100 is displayed, when the user authentication by the user authenticating unit 106 is successful.

The initial menu screen shown in FIG. 4 includes four menu icons, a menu icon 304 for displaying a home screen specific to the user, a menu icon 303 for displaying a function screen, a menu icon 302 for displaying a job screen, and a menu icon 301 for displaying a history screen. It is assumed that the menu icon 302 is selected to display the job screen on the initial menu screen. The menu icons respectively correspond to menu items, which are items of respective functions of the apparatus (the MFP 100) to give a selection instruction of each menu item.

Multi-processing icons 41 and 42, which are icons corresponding to the “job” menu icon 302 for selecting and instructing a function to be executed by the MFP 100, an input icon group A (31 and 32), and an output icon group B (33, 34, and 35) are arranged and displayed below the menu icons 301, 302, 303, and 304 on the initial menu screen (selection screen).

A scroll bar 320 is displayed on the right side of the multi-processing icon, the input icon, and the output icon, so that display of the multi-processing icon, the input icon, and the output icon, which cannot be displayed on the LCD touch panel 220, can be scrolled and displayed.

The multi-processing icon, the input icon, and the output icon are explained in detail with reference to FIG. 4. The input icon 31 performs the input process of scanning a document placed by the user, the input icon 32 performs the input process of receiving an email via the network, and these input icons form the input icon group A. The output icon 33 performs the output process of printing data acquired through the input process (for example, data acquired by scanning the document or the like), the output icon 34 performs the output process of storing the data acquired through the input process on a storage medium or the like, and the output icon 35 performs the output process of transmitting the acquired data by email to any address via the network, and these output icons form the output icon group B.

The multi-processing icon 41 includes an image of the input icon 31 and an image of the output icon 35, which instructs to perform the input process of scanning the document placed by the user and the output process of transmitting the scanned data by email in a row. The multi-processing icon 42 includes an image of the input icon 32 and an image of the output icon 34, which instructs to perform the input process of receiving an email via the network and the output process of printing the received email in a row.

An arrangement of the image of the input icon (hereinafter, “input icon image”) and the image of the output icon (hereinafter, “output icon image”) constituting the multi-processing icon is explained below. FIG. 5 is a schematic diagram for explaining one example of the configuration of the multi-processing icon. As shown in FIG. 5, for example, a multi-processing icon 401 has a square frame, and an input icon image 1 is arranged at the upper left in the square frame and the output icon image 2 at the lower right in the square frame. By locating the input icon image and the output icon image in this manner, when the multi-processing icon 401 is selected, the processing content can be ascertained at a glance such that after the input process corresponding to the upper left input icon image is performed, the output process corresponding to the lower right output icon image is performed. It can be set such that the input process and the output process are simultaneously performed.

The input receiving unit 103 receives a key event by a selection input of a menu icon of a desired menu by the user among a plurality of menu icons on the initial menu screen or the like displayed by the display processing unit 101. The input receiving unit 103 also receives a key event by a selection input of the input icon, the output icon, or the multi-processing icon displayed on the initial menu screen. Specifically, when the user presses the multi-processing icon or the like displayed on the LCD touch panel 220 by using the display processing unit 101, the input receiving unit 103 receives the key event corresponding to the multi-processing icon or the like, assuming that the pressed multi-processing icon or the like is selected and input. The input receiving unit 103 also receives an input key event from various buttons such as the initial setting key 201. The input receiving unit 103 further receives a selection input by the user indicating that the multi-processing icon including the input icon image and the output icon image corresponding to the input process and the output process performed by the execution processing unit 105 is to be generated. The instruction to generate the multi-processing icon is received that by the selection input by the user on a multi-processing icon generation instruction screen (not shown) displayed on the liquid-crystal display unit of the operation panel, at the time of performing the input and output processing.

The execution processing unit 105 includes an input processing unit 111 and an output processing unit 112, to perform the input process corresponding to the input icon or the output process corresponding to the output icon using the function of the MFP 100. Upon reception of the multi-processing icon by the input receiving unit 103, the execution processing unit 105 simultaneously or in a row performs the input process corresponding to the input icon image and the output process corresponding to the output icon image included in the received multi-processing icon. Specifically, upon reception of the multi-processing icon by the input receiving unit 103, the execution processing unit 105 refers to the process correspondence table stored in the storage unit 104, to perform processes corresponding to the icon name of the received multi-processing icon simultaneously or in a row. With regard to the input icon and the output icon, the execution processing unit 105 refers to the process correspondence table to perform the process corresponding to the respective icon names. The respective controllers included in the service layer 152 control the hardware resources based on the content processed by the execution processing unit 105 to perform the input process and the output process using the hardware.

Upon reception of the multi-processing icon including a total of three or more input and output icon images by the input receiving unit 103, the execution processing unit 105 simultaneously or in a row performs a total of three or more input and output processes corresponding to the input and output icon images included in the received multi-processing icon.

When the execution processing unit 105 performs the input process corresponding to the input icon and the output process corresponding to the output icon received by the input receiving unit 103, the icon generating unit 102 generates a multi-processing icon including the executed input icon and output icon. Specifically, the icon generating unit 102 refers to the process correspondence table stored in the storage unit 104, to read the processing contents and the icon images corresponding to the icon names of the input process and the output process performed by the execution processing unit 105, and generates a multi-processing icon in which the read input icon image and output icon image are arranged.

The icon generating unit 102 stores the image of the generated multi-processing icon (multi-processing icon image) in the process correspondence table in the storage unit 104, and registers the image in association with the processing content corresponding to the icon name of the generated multi-processing icon in the process correspondence table. The icon generating unit 102 can generate a multi-processing icon in which an input icon image and an output icon image selected by the user for generating the multi-processing icon are arranged, even if the process has not been performed by the execution processing unit 105.

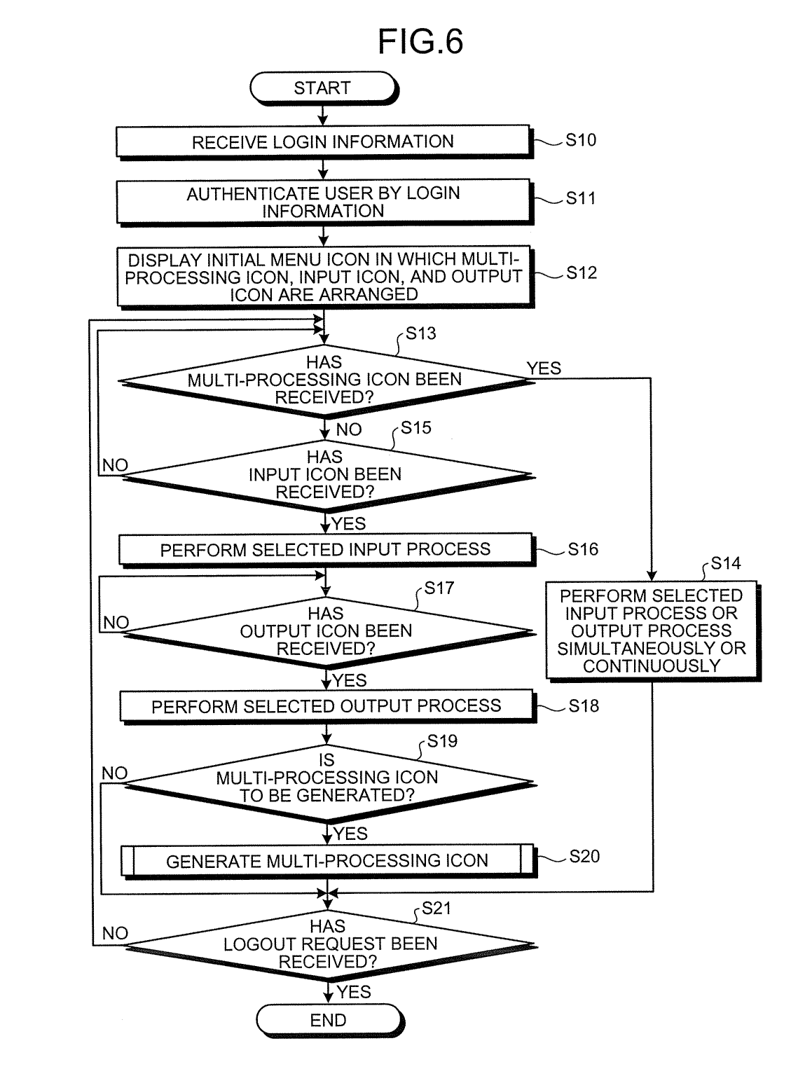

A display process by the MFP 100 according to the first embodiment is explained next. FIG. 6 is a flowchart of an overall flow of the display process in the first embodiment.

The input receiving unit 103 receives login information input by the user (Step S10). Specifically, the input receiving unit 103 receives a user name and a password input on a login screen as the login information. The login screen is displayed, for example, when the user selects a login button displayed on the initial screen.

The user authenticating unit 106 performs user authentication based on the login information received by the input receiving unit 103 (Step S11). When the user authentication is successful, the display processing unit 101 displays a home screen of the user and then displays the initial menu screen selected by the user. That is, the display processing unit 101 displays the initial menu screen on which the menu icon, the multi-processing icon, the input icon, and the output icon are arranged (Step S12). One example of the initial menu screen is shown in FIG. 4.

The input receiving unit 103 then determines whether a selection input of the multi-processing icon has been received from the user, according to reception of the key event of the multi-processing icon (Step S13). When the selection input of the multi-processing icon has been received by the input receiving unit 103 (YES at Step S13), the execution processing unit 105 refers to the process correspondence table (FIG. 2), to read the processing content of the multi-processing icon corresponding to the received key event (input process corresponding to the input icon image included in the multi-processing icon and the output process corresponding to the output icon image included in the multi-processing icon), and performs control to perform the input process by the input processing unit 111 and the output process by the output processing unit 112 in a row. Accordingly, the input processing unit 111 in the execution processing unit 105 performs the input process corresponding to the input icon image included in the selected multi-processing icon, and the output processing unit 112 in the execution processing unit 105 performs the output process corresponding to the output icon image included in the selected multi-processing icon in a row (Step S14). Control then proceeds to Step S21.

When the selection input of the multi-processing icon has not been received (NO at Step S13), the input receiving unit 103 determines whether a selection input of the input icon has been received (Step S15). When the selection input of the input icon has not been received (NO at Step S15), the input receiving unit 103 returns to Step S13 to repeat the process again.

When the selection input of the input icon has been received by the input receiving unit 103 (YES at Step S15), the input processing unit 111 in the execution processing unit 105 performs the input process corresponding to the selected input icon (Step S16). The input receiving unit 103 then determines whether a selection input of the output icon has been received (Step S17). When the selection input of the output icon has not been received (NO at Step S17), the input receiving unit 103 returns to Step S17 to repeat the process again.

When the selection input of the output icon has been received by the input receiving unit 103 (YES at Step S17), the output processing unit 112 in the execution processing unit 105 performs the output process corresponding to the selected output icon (Step S18).

The input receiving unit 103 then determines whether a selection input by the user instructing to generate a multi-processing icon including the input icon image corresponding to the input process and the output icon image corresponding to the output process performed by the execution processing unit 105 has been received from the LCD touch panel 220 of the operation panel 200 (Step S19). When the selection input instructing to generate the multi-processing icons by the input receiving unit 103 has not been received (NO at Step S19), control proceeds to Step S21. On the other hand, when the selection input instructing to generate the multi-processing icons by the input receiving unit 103 has been received (YES at Step S19), the icon generating unit 102 generates the multi-processing icon (Step S20). The generation method of the multi-processing icon will be described later.

The input receiving unit 103 determines whether a logout request has been received (Step S21). The logout request is received, for example, when a logout button displayed on the lower part of the screen is pressed.

When the logout request has not been received (NO at Step S21), control returns to an input receiving process of the multi-processing icon to repeat the process (Step S13). On the other hand, when the logout request has been received (YES at Step S21), the display processing unit 101 displays the initial screen prior to login.

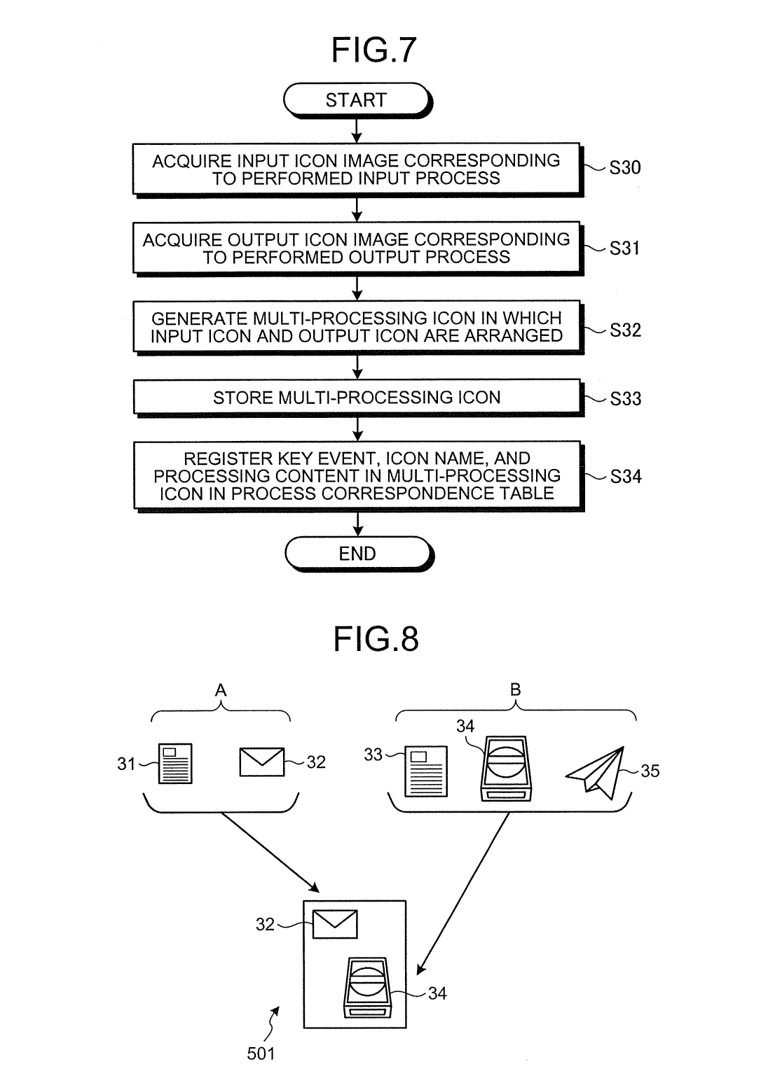

The generation method of the multi-processing icon by the MFP 100 according to the first embodiment (Step S20 in FIG. 6) is explained next. FIG. 7 is a flowchart of an overall flow of the multi-processing-icon generating process in the first embodiment.

At Step S19 in FIG. 6, upon reception of the selection input instructing to generate the multi-processing icon by the input receiving unit 103, the icon generating unit 102 refers to the process correspondence table stored in the storage unit 104, to read and acquire the processing content and the input icon image corresponding to the icon name of the input icon corresponding to the input process performed by the execution processing unit 105 (Step S30). The icon generating unit 102 then refers to the process correspondence table stored in the storage unit 104, to read and acquire the processing content and the output icon image corresponding to the icon name of the output icon corresponding to the output process performed by the execution processing unit 105 (Step S31).

The icon generating unit 102 generates the multi-processing icon in which the acquired input icon image and output icon image are arranged (Step S32). The icon generating unit 102 stores the multi-processing icon image of the generated multi-processing icon in the process correspondence table in the storage unit 104 (Step S33), and generates the key event and the icon name unique to the generated multi-processing icon. The icon generating unit 102 then registers the generated key event, the icon name, and the input process and the output process included in the multi-processing icon as the processing content in the process correspondence table in association with each other (Step S34).

The generating process of the multi-processing icon is explained with reference to the accompanying drawings. FIG. 8 is a schematic diagram for explaining the multi-processing-icon generating process. The input icon group A includes the input icon 31 for performing a scanning process and the input icon 32 for receiving an email, when selected. The output icon group B includes the output icon 33 for printing, the output icon 34 for saving, and the output icon 35 for transmitting an email, when selected. When email reception is performed as the input process, and saving is performed as the output process, the icon generating unit 102 acquires and arranges the image of the executed input icon 32 and the image of the executed output icon 34 among a plurality of icons, to generate a multi-processing icon 501.

The arrangement and the like of the input icon image and the output icon image at the time of generating the multi-processing icon are explained next. In the multi-processing icon, the processing icon images are arranged at the upper left and the lower right in a square frame (see FIG. 5); however, the multi-processing icon can be generated as described below.

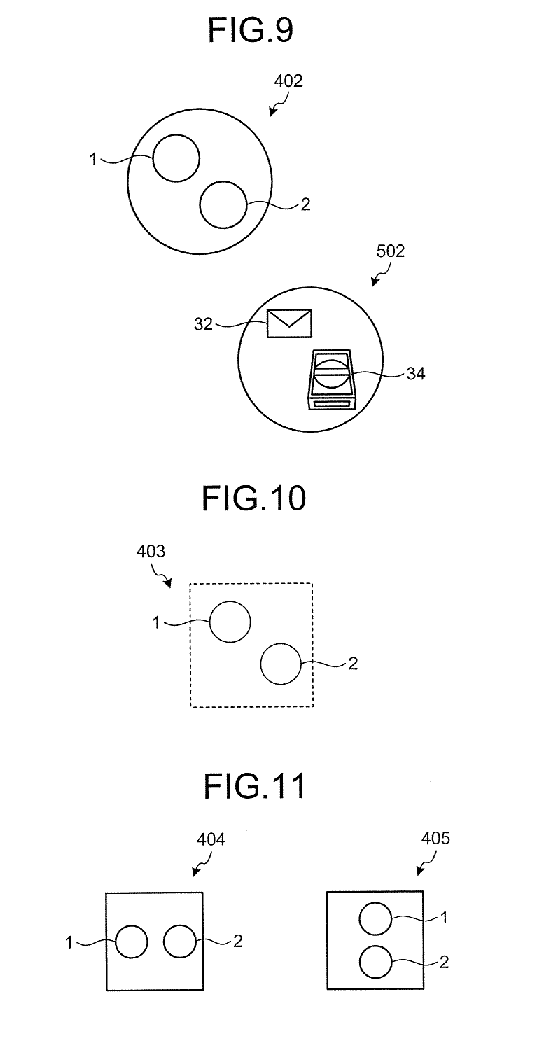

FIG. 9 is a schematic diagram for explaining another example of the configuration of the multi-processing icon. As shown in FIG. 9, a multi-processing icon 402 has a circular frame, and the input icon image 1 is arranged at the upper left and an output icon image 2 is arranged at the lower right in the circular frame. By locating the input icon image and the output icon image in this manner, when the multi-processing icon 402 is selected, the processing content and the process procedure can be ascertained at a glance such that after the input process corresponding to the upper left input icon image is performed, the output process corresponding to the lower right output icon image is performed, as in the case of arrangement in the square frame.

One example when the input icon image and the output icon image are actually arranged is shown as a multi-processing icon 502. In the multi-processing icon 502, the image of the input icon 32 for receiving an email is arranged at the upper left and the image of the output icon 34 for saving the received data is arranged at the lower right in the circular frame. By displaying such a multi-processing icon 502, it can be ascertained at a glance that after the email receiving process is performed, the received data is stored on a storage medium or the like.

FIG. 10 is a schematic diagram for explaining another example of the configuration of the multi-processing icon. As shown in FIG. 10, a multi-processing icon 403 does not include a square or circular frame, and the output icon image 2 is arranged at the lower right of the input icon image 1 on a transparent background.

FIG. 11 is a schematic diagram for explaining another example of the configuration of the multi-processing icon. As shown in FIG. 11, a multi-processing icon 404 has a square frame, and the input icon image 1 is arranged at the center left and the output icon image 2 is arranged at the center right in the square frame. Further, a multi-processing icon 405 is such that there is a square frame, and the input icon image 1 is arranged at the upper center and the output icon image 2 is arranged at the lower center in the square frame.

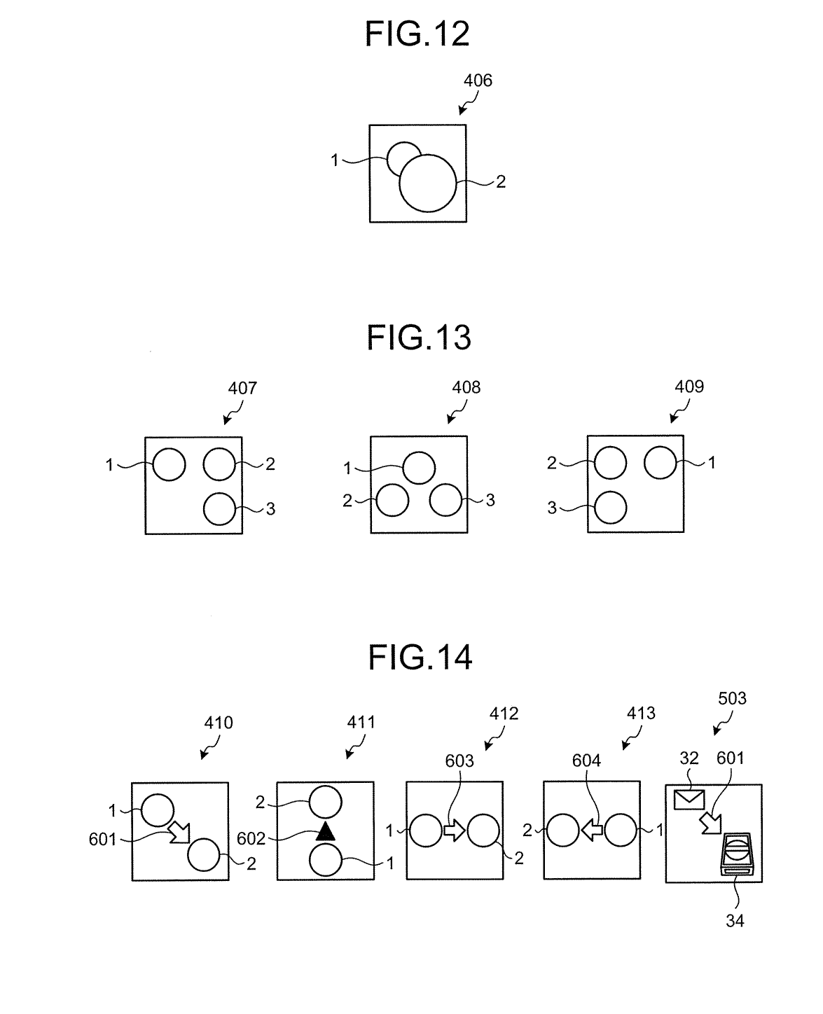

FIG. 12 is a schematic diagram for explaining another example of the configuration of the multi-processing icon. As shown in FIG. 12, a multi-processing icon 406 is such that there is a square frame, and the input icon image 1 is arranged at the upper left in the square frame and the output icon image 2 having a larger image size than that of the input icon image 1 is arranged at the lower right, superposed on a part of the input icon image 1.

A multi-processing icon in which one input icon image and two output icon images are arranged is explained. FIG. 13 is a schematic diagram for explaining other examples of the configuration of the multi-processing icon. As shown in FIG. 13, a multi-processing icon 407 is such that there is a square frame, and the input icon image 1 is arranged at the upper left in the square frame and the output icon images 2 and 3 are arranged side by side on the right thereof. In a multi-processing icon 408, the input icon image 1 is arranged at the upper part in the square frame and the output icon images 2 and 3 are arranged side by side in the lower part. In a multi-processing icon 409, the input icon image 1 is arranged at the right in the square frame and the output icon images 2 and 3 are arranged side by side on the left thereof.

Further, a multi-processing icon is explained such that an input icon image and an output icon image are arranged, and a relational image indicating the relation between the input icon image and the output icon image is also arranged. The relational image indicates the relation between the input icon image and the output icon image such as an execution sequence of the input and output processes, and is an icon such as an arrow, borderline image, character, or linear image.

A multi-processing icon indicating the processing sequence by indicating the relation between the input icon image and the output icon image by an arrow is explained first. FIG. 14 is a schematic diagram for explaining other examples of the configuration of the multi-processing icon. As shown in FIG. 14, in a multi-processing icon 410, there is a square frame and the input icon image 1 is arranged at the upper left and the output icon image 2 is arranged at the lower right in the square frame, and an arrow 601 starting from the upper left toward the lower right (relational image) is also arranged. The arrow 601 indicates that after the input process corresponding to the upper left input icon image 1 is performed, the output process corresponding to the lower right output icon image 2 is performed, thereby enabling to easily ascertain the processing content and the processing sequence of the multi-processing icon.

One example when the input icon image and the output icon image are actually arranged is shown as a multi-processing icon 503. In the multi-processing icon 503, the image of the input icon 32 for receiving an email is arranged at the upper left and the image of the output icon 34 for saving the received data is arranged at the lower right in the circular frame, and the arrow 601 starting from the upper left toward the lower right (relational image) is also arranged. By displaying the thus arranged multi-processing icon 503, it can be ascertained more easily due to the arrow 601 that after the email receiving process is performed, the received data is stored on a storage medium or the like.

Further, as shown in FIG. 14, in a multi-processing icon 411, there is a square frame and the input icon image 1 is arranged in the lower part in the square frame, the output icon image 2 is arranged in the upper part, and a triangular arrow 602 (relational image) directed upward is arranged.

In a multi-processing icon 412, there is a square frame and the input icon image 1 is arranged at the left in the square frame, the output icon image 2 is arranged at the right, and an arrow 603 (relational image) directed from the left to the right is arranged. In a multi-processing icon 413, there is a square frame and the input icon image 1 is arranged at the right in the square frame, the output icon image 2 is arranged at the left, and an arrow 604 (relational image) directed from the right to the left is arranged.

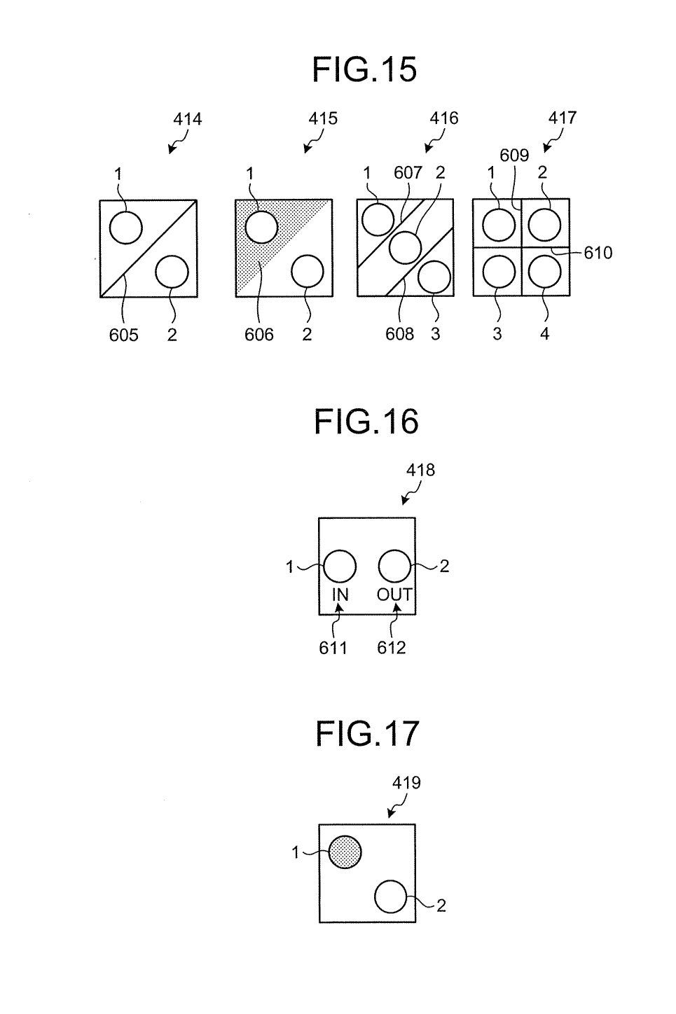

A multi-processing icon in which an area in the square frame is divided to arrange the input icon image and the output icon image is explained. FIG. 15 is a schematic diagram for explaining other examples of the configuration of the multi-processing icon. As shown in FIG. 15, in a multi-processing icon 414, there is a square frame and a borderline image 605 (relational image) for dividing the square frame into an upper left area and a lower right area is arranged, and the input icon image 1 is arranged in the upper left area and the output icon image 2 is arranged in the lower right area. In a multi-processing icon 415, there is a square frame and the inside of the square frame is divided into an upper left area 606 and a lower right area by changing the color of the upper left area 606, and the input icon image 1 is arranged in the upper left area and the output icon image 2 is arranged in the lower right area.

In the case of generating a multi-processing icon in which one input icon image and two output icon images are arranged, in a multi-processing icon 416, there is a square frame and borderline images 607 and 608 (relational image) for dividing the square frame into an upper left area, a central area, and a lower right area are arranged, and the input icon image 1 is arranged in the upper left area, the output icon image 2 is arranged in the central area, and an output icon image 3 is arranged in the lower right area.

In the case of generating a multi-processing icon in which one input icon image and three output icon images are arranged, in a multi-processing icon 417, there is a square frame and the inside of the square frame is divided into four areas by borderline images 609 and 610 (relational image), and the input icon image 1 and the output icon images 2, 3, and 4 are arranged in the respective areas.

A multi-processing icon in which a character is respectively arranged near the input icon image and the output icon image is explained. FIG. 16 is a schematic diagram for explaining another example of the configuration of the multi-processing icon. As shown in FIG. 16, in a multi-processing icon 418, there is a square frame, the input icon image 1 is arranged at the left in the square frame and the output icon image 2 is arranged at the right, and a character “in” 611 (relational image) indicating the input process is arranged below the input icon image, and a character “out” 612 (relational image) indicating the output process is arranged below the output icon image. Accordingly, it can be easily ascertained that the displayed icon performs the input process or the output process.

A multi-processing icon in which the input icon image and the output icon image having different colors from each other are arranged is explained. FIG. 17 is a schematic diagram for explaining another example of the configuration of the multi-processing icon. As shown in FIG. 17, in a multi-processing icon 419, there is a square frame, and the input icon image 1 is arranged at the upper left in the square frame and the output icon image 2 having a different color is arranged at the lower right. Accordingly, it can be easily ascertained that the displayed icon performs the input process or the output process.

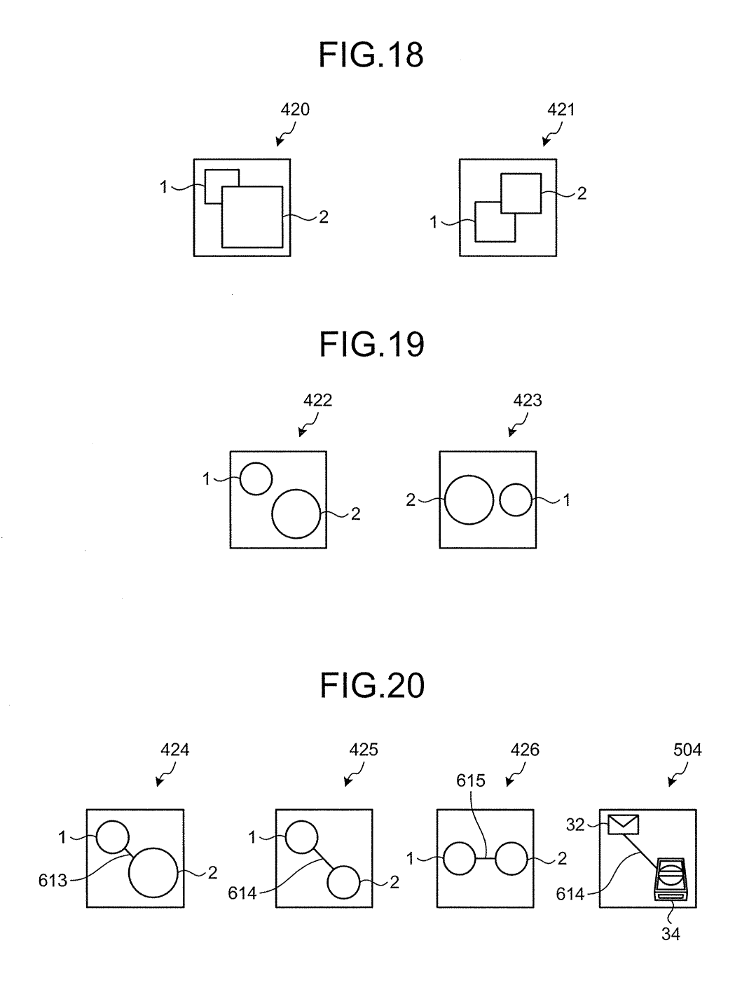

A multi-processing icon in which the input icon image and the output icon image are superposedly arranged is explained. FIG. 18 is a schematic diagram for explaining another example of the configuration of the multi-processing icon. As shown in FIG. 18, in a multi-processing icon 420, there is a square frame, and the input icon image 1 is arranged at the upper left in the square frame and the output icon image 2 is arranged at the lower right, superposed on a part of the input icon image 1. In a multi-processing icon 421, the input icon image 1 is arranged at the lower left in the square frame and the output icon image 2 is arranged at the upper right, superposed on a part of the input icon image 1. Accordingly, it can be seen that the input icon image is arranged on the far side and the output icon image is arranged on the near side. That is, it can be easily ascertained that the displayed icon performs the input process or the output process according to a vertical positional relation of the superposed icons.

A multi-processing icon in which the input icon image and the output icon image having different sizes from each other are arranged is explained. FIG. 19 is a schematic diagram for explaining other examples of the configuration of the multi-processing icon. As shown in FIG. 19, in a multi-processing icon 422, there is a square frame, and the input icon image 1 is arranged at the upper left in the square frame and the output icon image 2 larger than the input icon image 1 is arranged at the lower right. Further, in a multi-processing icon 423, the input icon image 1 is arranged at the right and the output icon image 2 larger than the input icon image 1 is arranged at the left. Accordingly, it can be easily ascertained that the smaller icon performs the input process, and the larger icon performs the output process.

A multi-processing icon in which a linear image connecting the input icon image and the output icon image is arranged is explained. FIG. 20 is a schematic diagram for explaining other examples of the configuration of the multi-processing icon. As shown in FIG. 20, in a multi-processing icon 424, there is a square frame, and the input icon image 1 is arranged at the upper left in the square frame and the output icon image 2 larger than the input icon image 1 is arranged at the lower right, and further, a linear image 613 (relational image) connecting the input icon image 1 and the output icon image 2 is arranged. Accordingly, it is shown that after the input process corresponding to the input icon image 1 is performed, the output process corresponding to the output icon image 2 is performed, that is, it can be easily ascertained that the input process and the output process are in a row performed.

In a multi-processing icon 425, there is a square frame, and the input icon image 1 is arranged at the upper left in the square frame and the output icon image 2 is arranged at the lower right, and further, a linear image 614 (relational image) connecting the input icon image 1 and the output icon image 2 is arranged. Accordingly, it can be easily ascertained that the input process and the output process are in a row performed as in the above example. A multi-processing icon 504 shows an example in which the input icon image and the output icon image are actually arranged. In the multi-processing icon 504, an image of the input icon 32 for receiving an email is arranged at the upper left in the square frame, an image of the output icon 34 for saving the received data is arranged at the lower right, and the linear image 614 connecting the image of the input icon 32 and the image of the output icon 34 is arranged. By displaying the multi-processing icon 504 thus arranged, it can be easily ascertained that after the email receiving process is performed, the process of saving the received data on a storage medium or the like is performed in a row.

In a multi-processing icon 426, there is a square frame, and the input icon image 1 is arranged at the left in the square frame and the output icon image 2 is arranged at the right, and further, a linear image 615 (relational image) connecting the input icon image 1 and the output icon image 2 is arranged. Accordingly, the processing sequence and continuous performing of the processes can be easily ascertained as in the above example.

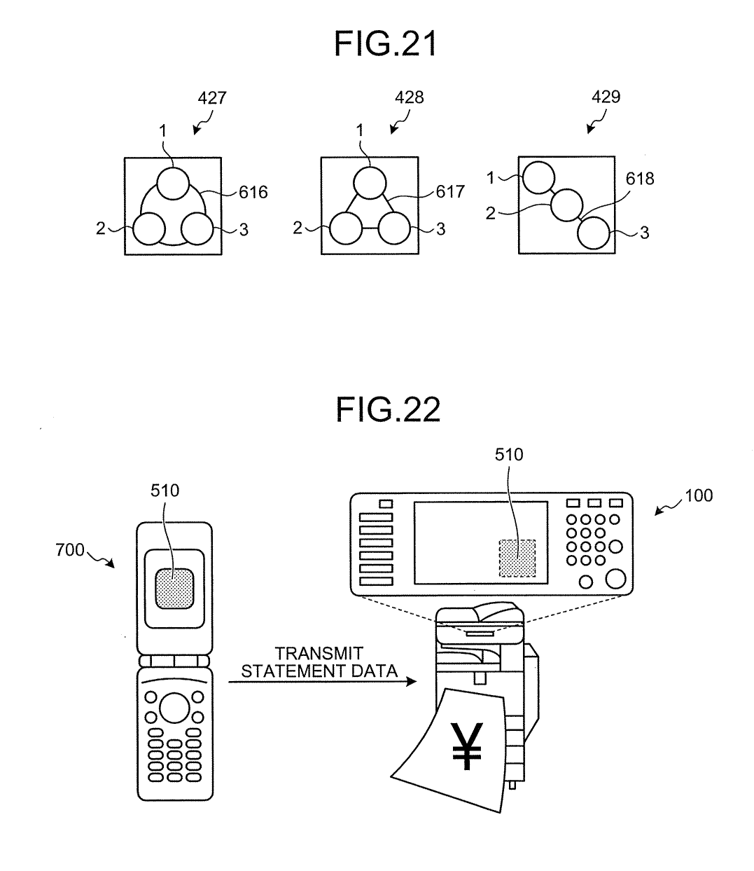

When it is assumed that the input process and the output process are processes on an equal footing, a multi-processing icon in which the linear image connecting the input icon image and the output icon image is arranged is explained. That is, for example, it can be considered a case where processes in the multi-processing icon are performed simultaneously. FIG. 21 is a schematic diagram for explaining other examples of the configuration of the multi-processing icon. As shown in FIG. 21, in a multi-processing icon 427, there is a square frame, and the input icon image 1 is arranged in the upper part in the square frame, the output icon images 2 and 3 are arranged in the lower part, and a linear image 616 (relational image) is arranged to connect these icons circularly. Accordingly, it is shown that all the processes are on an equal footing, and the processing contents thereof can be seen at a glance.

In a multi-processing icon 428, there is a square frame, and the input icon image 1 is arranged in the upper part in the square frame, the output icon images 2 and 3 are arranged in the lower part, and a linear image 617 (relational image) is arranged to connect these icons triangularly. In a multi-processing icon 429, the input icon image 1 is arranged at the upper left in the square frame, the output icon image 2 is arranged in the center, the output icon image 3 is arranged at the lower right, and a linear image 618 (relational image) is arranged to connect these icons linearly.

Further, a multi-processing icon in which the input icon image and the output icon image are formed in annotations can be generated.

As described above, the multi-processing icon can be displayed in a square or circular shape. The input icon image and the output icon image included in the multi-processing icon can be arranged in various positions, so that the processing content and the execution sequence can be ascertained. Further, by displaying in the multi-processing icon the relational image such as an arrow indicating the relation between the input icon image and the output icon image, the processing content and the execution sequence can be ascertained more easily.

In the display processing apparatus (MFP) according to the first embodiment, processes can be selected and performed simultaneously by receiving a selection input of the multi-processing icon concisely displaying a plurality of processing contents. Accordingly, the operation procedure can be simplified, and the operability at the time of performing the processes simultaneously or in a row can be improved. Further, the processing contents to be executed can be easily ascertained by displaying the multi-processing icon including the input icon image corresponding to the input process and the output icon image corresponding to the output process on the LCD touch panel 220. An operational error can be prevented by receiving a selection input of processes by the multi-processing icon. Further, because the multi-processing icon can be generated and registered by combining the performed input process and output process, when the same processes are to be performed again, the generated multi-processing icon can be used. Accordingly, the operation procedure can be further simplified, thereby preventing an operational error.

The MFP according to the first embodiment performs processes by displaying the multi-processing icons including the input icon image and the output icon image and receiving a selection input of the multi-processing icon from the user. On the other hand, in a second embodiment of the present invention, a multi-processing icon including an image of a processing icon (hereinafter, “processing icon image”) corresponding to a process respectively performed by a mobile phone and the MFP is displayed on the mobile phone, and the mobile phone and the MFP perform the processes in a row by receiving a selection input of the multi-processing icon from the user.

An outline of the processes performed by the mobile phone and the MFP in the second embodiment is explained with reference to the accompanying drawings. FIG. 22 is a schematic diagram for explaining the outline of the processes to be performed by the mobile phone and the MFP according to the second embodiment.

As shown in FIG. 22, in the second embodiment, an Internet function such as i-mode (registered trademark) of a mobile phone 700 is used to make payment of various fees (for example, price of purchasing merchandise, transit fare, room charge, payment of public utility charges and the like, and credit payment) by the mobile phone 700, and data of statement of the paid fee (statement data) is stored. Upon reception of a selection input of a multi-processing icon 510 (details thereof will be described later) from the user, the mobile phone 700 transmits the statement data to the MFP 100, so that the MFP 100 prints the statement data. In other words, the multi-processing icon specifies to perform the transmitting process of the statement data by the mobile phone 700 and the printing process of the statement data by the MFP 100 in a row. At this time, it is also possible to display the multi-processing icon 510 on the MFP 100, to print the received statement data directly (automatic printing), or to print the received statement data after print setup is performed by the MFP 100 (manual printing).

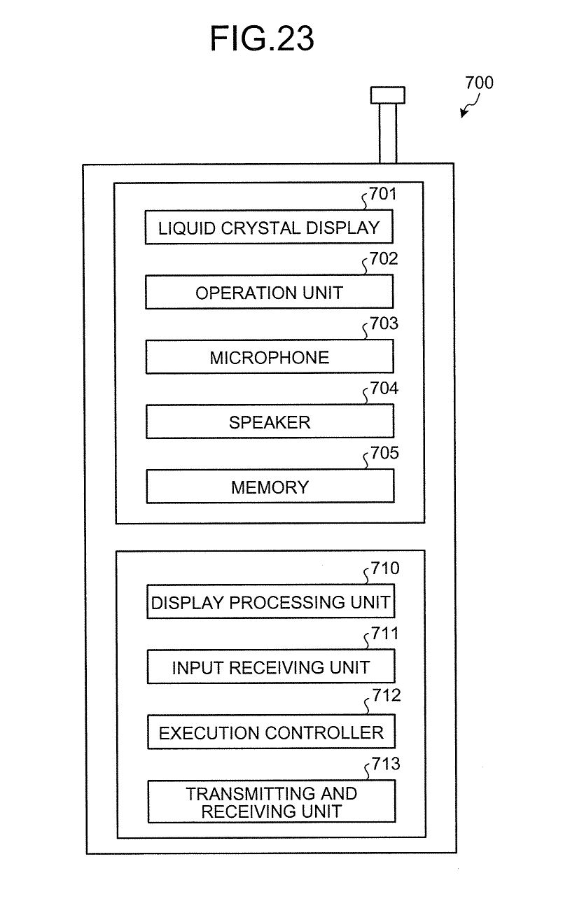

Details of the mobile phone 700 are explained next. FIG. 23 is a functional block diagram of the mobile phone according to the second embodiment. As shown in FIG. 23, the mobile phone 700 mainly includes an LCD 701, an operation unit 702, a microphone 703, a speaker 704, a memory 705, a display processing unit 710, an input receiving unit 711, an execution controller 712, and a transmitting and receiving unit 713.

The LCD 701 displays characters and images. The operation unit 702 inputs data by a key or button. The microphone 703 receives voice data. The speaker 704 outputs voice data.

The memory 705 is a storage medium that stores a message to be sent or received via the network, and characters and images to be displayed on the LCD 701. The memory 705 also stores processing icons, multi-processing icons, and statement data indicating paid amounts. The processing icon respectively corresponds to processes (input process and output process) by respective functions of the mobile phone 700 and the MFP 100, to give a selection instruction of processes by respective functions. The multi-processing icon represents an icon including a plurality of processing icon images, and when selected, processes corresponding to the included processing icon images are performed in a row.

The display processing unit 710 displays various data such as messages to be sent and received and various screens on the LCD 701. The display processing unit 710 also displays processing icons and multi-processing icons. Specifically, for example, the display processing unit 710 displays, on the LCD 701, a multi-processing icon including an image of a transmission icon (transmission icon image) corresponding to the transmitting process performed by the mobile phone 700 and an image of a printing icon (printing icon image) corresponding to the printing process performed by the MFP 100, for giving a selection instruction to perform the transmitting process corresponding to the included transmission icon image and the printing process corresponding to the included printing icon image in a row.

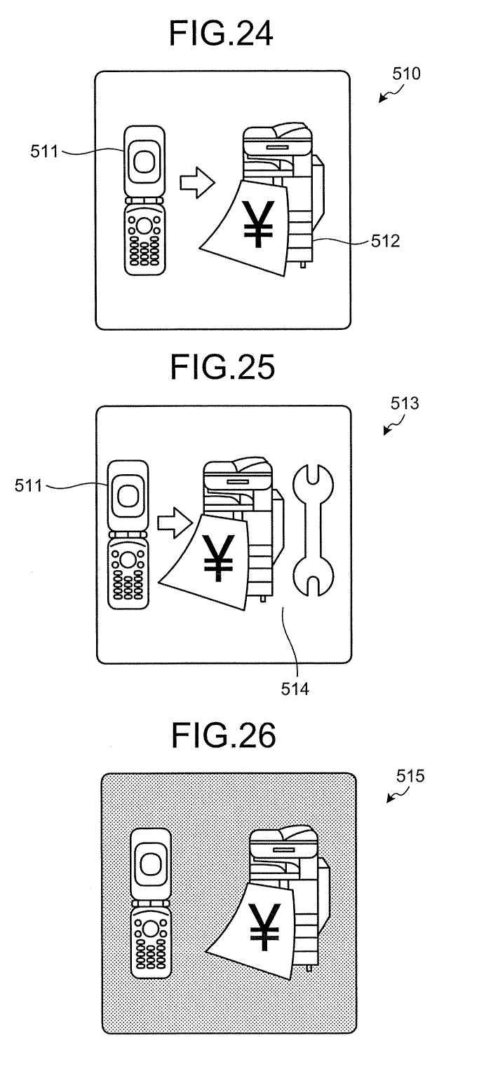

Details of the multi-processing icon displayed in the second embodiment are explained. FIG. 24 is a schematic diagram for explaining one example of the configuration of the multi-processing icon displayed on the mobile phone. The multi-processing icon 510 includes a transmission icon image and a printing icon image, and when a selection instruction is received from the user, the transmitting process is performed by the mobile phone 700 to transmit the statement data to the MFP 100 via the network, and the printing process is performed by the MFP 100 to receive the statement data from the mobile phone 700 and print the received statement data. As shown in FIG. 24, in the multi-processing icon 510, a processing icon 511 indicates the transmitting process of the statement data by the mobile phone and an arrow from the mobile phone to the MFP, and a processing icon 512 indicates the printing process of the statement data by the MFP and the statement data. The multi-processing icon 510 is also displayed on the LCD touch panel of the MFP 100, to indicate that the function is included in the MFP 100.

The input receiving unit 711 receives transfer of messages, a display instruction of various screens, and the like from the user. The input receiving unit 711 further receives a specification input of the statement data to be printed and a selection input of the multi-processing icon from the user.

When having received a selection input of the multi-processing icon by the input receiving unit 711, the execution controller 712 controls respective components to perform processes corresponding to the processing icon images included in the received multi-processing icon. Specifically, for example, when the input receiving unit 711 receives a specification input of the statement data and a selection input of the multi-processing icon including the transmission icon image and the printing icon image (see FIG. 24), the execution controller 712 controls the transmitting and receiving unit 713 to transmit the specified statement data and a printing instruction for performing the printing process corresponding to the printing icon image to the MFP 100, as the transmitting process corresponding to the transmission icon image included in the received multi-processing icon.

The transmitting and receiving unit 713 performs transfer of emails and reception of the statement data. Further, the transmitting and receiving unit 713 performs the transmitting process corresponding to the transmission icon image, for example, the transmitting process of transmitting the statement data and a printing instruction.

The mobile phone 700 stores the process correspondence table as in the first embodiment shown in FIG. 2 on a storage medium such as a memory, and registers the key event, icon name, and processing contents of processes with respect to the multi-processing icon. In the second embodiment, as the processing content corresponding to the multi-processing icon, the transmitting process of the statement data and a printing-instruction transmitting process of the statement data with respect to the MFP 100 are registered. Because the printing process is performed by the MFP 100, the printing-instruction transmitting process of the statement data is registered as the processing content in the process correspondence table.

Details of the MFP 100 are explained next. Because the MFP 100 has the same configuration as that of the MFP according to the first embodiment, only a configuration of a different function is explained with reference to FIG. 1.

The communication control 126 receives data and the like from the mobile phone 700. For example, the communication control 126 receives the specified statement data and a printing instruction from the mobile phone 700. The received statement data and the printing instruction are input by the input processing unit 111.

The output processing unit 112 includes a printing unit (not shown) that performs processing by the plotter control 122, and the printing unit performs the data printing process. For example, the printing unit performs the printing process of the received statement data according to the printing instruction received from the mobile phone 700.

The display processing unit 101 has a function for displaying a multi-processing icon for display only on the LCD touch panel 220, in addition to the function explained in the first embodiment. Specifically, for example, the display processing unit 101 displays the multi-processing icon for display including the transmission icon image corresponding to the transmitting process performed by the mobile phone 700 and the printing icon image corresponding to the printing process performed by the MFP 100, for displaying that the MFP 100 includes a function for in a row performing the transmitting process corresponding to the included transmission icon image and the printing process corresponding to the included printing icon image. The multi-processing icon for display has the same configuration as that of the multi-processing icon shown in FIG. 24, however, a selection instruction thereof is not possible.

Another multi-processing icon for display is explained. FIG. 25 is a schematic diagram for explaining another example of the configuration of the multi-processing icon for display to be displayed on the MFP. A multi-processing icon for display 513 includes the transmission icon image and the printing icon image, for displaying the transmitting process of transmitting the statement data from the mobile phone 700 to the MFP 100 via the network, and the printing process of printing the statement data when the statement data is received by the MFP 100 from the mobile phone 700 and the print setup of the received statement data is performed by the MFP 100. As shown in FIG. 25, in the multi-processing icon for display 513, the processing icon 511 indicates the transmitting process of the statement data from the mobile phone 700 by the mobile phone and an arrow from the mobile phone to the MFP, and a processing icon 514 indicates the printing process of the statement data, for which print setup is possible on the MFP 100 side, by the MFP, the statement data, and a wrench. By displaying the multi-processing icon for display 513, it can be ascertained that print setup of the received statement data is possible.

FIG. 26 is a schematic diagram for explaining another example of the configuration of the multi-processing icon for display to be displayed on the MFP. A multi-processing icon for display 515 has the same configuration as that of the multi-processing icon 510 (see FIG. 24); however, as shown in FIG. 26, display is made in gray color. Accordingly, the multi-processing icon for display 515 indicates that the received statement data is printed in monochrome on the MFP 100 side.

A display executing process performed by the mobile phone 700 and the MFP 100 according to the second embodiment is explained. FIG. 27 is a flowchart of an overall flow of a display executing process in the second embodiment. An automatic printing mode in which the icon explained with FIG. 24 is considered as a multi-processing icon to perform the process, and the received statement data is directly printed is explained. The display process of the multi-processing icon by the mobile phone 700 is controlled by the execution controller 712 in the following manner.

First, after payment of various fees is performed by the mobile phone 700, the input receiving unit of the mobile phone 700 receives a specification input of statement data to be printed and a multi-processing icon from the user (Step S40). The transmitting and receiving unit 713 transmits the statement data received by the input receiving unit 711 and a printing instruction for performing the printing process corresponding to the printing icon image to the MFP 100, as the transmitting process corresponding to the transmission icon image included in the received multi-processing icon (Step S41).

The input receiving unit in the MFP 100 receives the statement data and a printing instruction from the mobile phone 700 (Step S42). The display processing unit 101 displays the transmission icon image corresponding to the transmitting process performed by the mobile phone 700 and the printing icon image corresponding to the printing process performed by the MFP 100 (Step S43). The printing unit prints the received statement data according to the received printing instruction (Step S44).

In the mobile phone 700 and the MFP 100 according to the second embodiment, after payment of various fees has been made by the mobile phone 700, upon reception of a selection input of a multi-processing icon, the mobile phone 700 transmits the statement data and a printing instruction to the MFP 100, and the MFP 100 prints the statement data. Therefore, a plurality of processes in different devices can be selected and performed simultaneously by receiving the selection input of the multi-processing icon concisely indicating a plurality of processing contents, thereby enabling to simplify the operation procedure and improve the operability at the time of performing the processes simultaneously or in a row. Further, by displaying the input icon image corresponding to the input process and the output icon image corresponding to the output process on the LCD 701, the processing contents to be executed can be easily ascertained, and an operational error can be prevented by receiving a selection input of processes by the multi-processing icon. Further, because multi-processing can be easily performed between a plurality of devices, the statement data of various fees paid by the mobile phone 700 can be easily printed out. Accordingly, expenditure can be regularly confirmed easily, and billing details can be seen in a list.

In the second embodiment, a multi-processing icon of processes performed by the mobile phone and the MFP is displayed to perform the processes by respective devices. In a third embodiment of the present invention, a multi-processing icon of processes performed by a digital camera, a personal computer (PC), and a projector is displayed, to perform the processes by respective apparatuses.

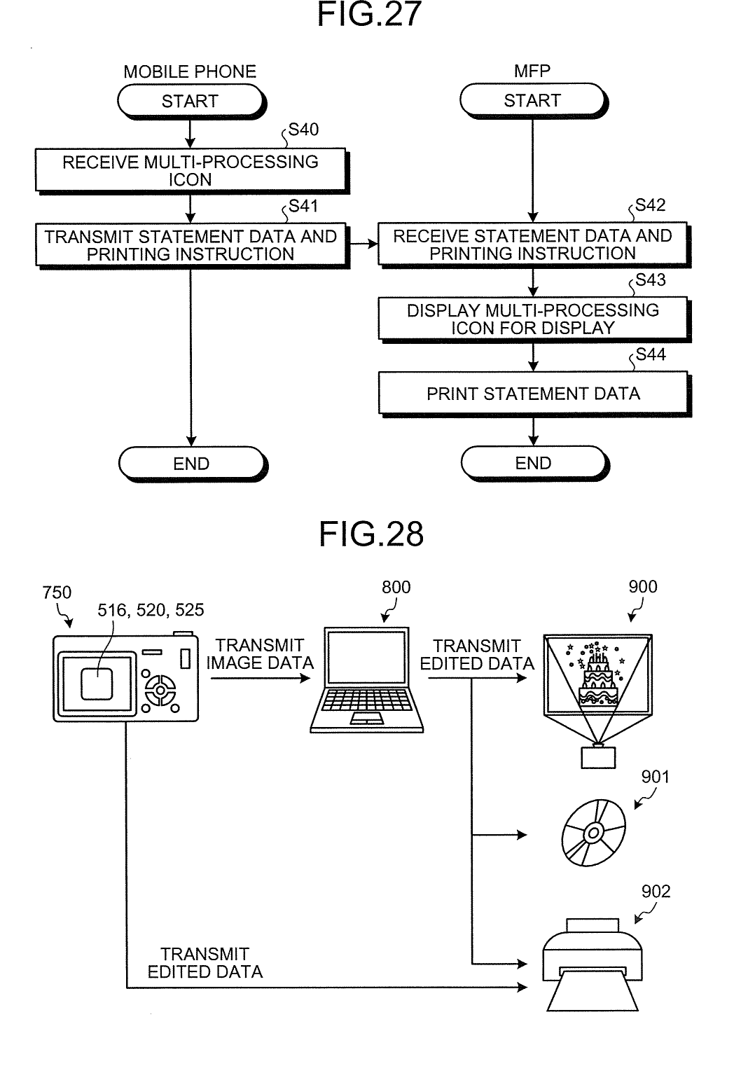

First, an output of a process performed by the digital camera, the PC, the projector, and the like according to the third embodiment is explained with reference to the accompanying drawings. FIG. 28 is a schematic diagram for explaining the outline of the process performed by the digital camera, the PC, the projector, and the like according to the third embodiment.

As shown in FIG. 28, in the third embodiment, when a subject is photographed by a digital camera 750, and a selection input of multi-processing icons 516 and 520 (described later in detail) is received from the user, the digital camera 750 transmits data of the imaged image (image data) to a PC 800, and the PC 800 edits the image data so that the edited data is displayed by a projector 900, stored in a compact disk recordable (CD-R) 901, or printed by a printer 902. Further, when a subject is photographed by the digital camera 750, and a selection input of a multi-processing icon 525 (will be described later in detail) is received from the user, edited data obtained by editing the image data by the digital camera 750 can be directly transmitted to the printer 902 and printed out without via the PC 800. That is, the transmitting process of image data by the digital camera 750, an image-data editing process by the PC 800, an image-data display process by the projector 900, a saving process on the CD-R, and the printing process by the printer 902 can be specified by a multi-processing icon displayed on the digital camera 750.

In the processing in the third embodiment, an image imaged by the digital camera, for example, in a wedding hall or an event site can be edited by the digital camera on the real time basis, and the edited image can be displayed to the visitors on the site, or a printed image (photograph) or an image stored on a CD-R can be distributed to the visitors.

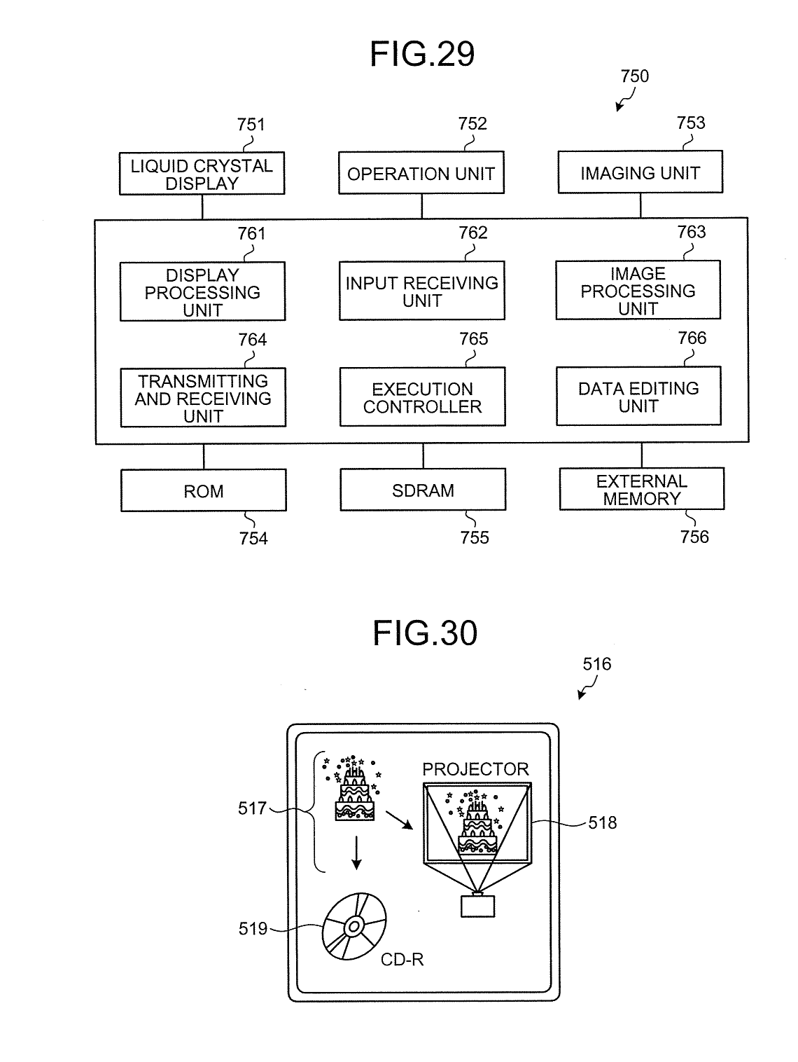

Details of the digital camera 750 are explained next. FIG. 29 is a functional block diagram of the digital camera according to the third embodiment. As shown in FIG. 29, the digital camera 750 mainly includes an LCD 751, an operation unit 752, an imaging unit 753, a read only memory (ROM) 754, a synchronous dynamic random access memory (SDRAM) 755, an external memory 756, a display processing unit 761, an input receiving unit 762, an image processing unit 763, a transmitting and receiving unit 764, an execution controller 765, and a data editing unit 766.

The LCD 751 displays characters, images, and imaged image data. The operation unit 752 inputs data and instructions by a button or the like. The imaging unit 753 images a subject.

The ROM 754 is a storage medium such as a memory for storing programs to be executed by the digital camera 750. The SDRAM 755 temporarily stores data required for execution of the program and the image data. The external memory 756 is a storage medium such as a memory card for storing the image data photographed by the digital camera 750.

The display processing unit 761 displays various data such as characters and images, various screens, and imaged image data on the LCD 751. The display processing unit 761 further displays processing icons and multi-processing icons. The processing icons are icons corresponding to processes (input process and output process) by respective functions of the digital camera 750, the PC 800, the projector 900, and the printer 902, for giving a selection instruction of the process by respective functions. The multi-processing icons are icons including images of a plurality of processing icons (processing icon images), for in a row performing processes corresponding to the included processing icon images, when selected.

Specifically, for example, the display processing unit 761 displays, on the LCD 751, a multi-processing icon including an image of the transmission icon (transmission icon image) corresponding to the transmitting process performed by the digital camera 750, an image of a display icon (display icon image) corresponding to the display process performed by the projector 900, and an image of a saving icon (saving icon image) corresponding to the saving process performed by the PC 800, for giving a selection instruction to perform the transmitting process corresponding to the included transmission icon image, the display process corresponding to the included display icon image, and the saving process corresponding to the included saving icon image in a row.

For example, the display processing unit 761 displays, on the LCD 751, a multi-processing icon including an image of the transmission icon (transmission icon image) corresponding to the transmitting process performed by the digital camera 750, an image of an editing icon (editing icon image) corresponding to the editing process performed by the PC 800, an image of a printing icon (printing icon image) corresponding to the printing process performed by the printer 902, and an image of a saving icon (saving icon image) corresponding to the saving process performed by the PC 800, for giving a selection instruction to perform the transmitting process corresponding to the included transmission icon image, the editing process corresponding to the included editing icon image, the printing process corresponding to the included printing icon image, and the saving process corresponding to the included saving icon image in a row.

Further, for example, the display processing unit 761 displays, on the LCD 751, a multi-processing icon including an image of the editing icon (editing icon image) corresponding to the editing process performed by the digital camera 750, an image of the transmission icon (transmission icon image) corresponding to the transmitting process performed by the digital camera 750, and an image of the printing icon (printing icon image) corresponding to the printing process performed by the printer 902, for giving a selection instruction to perform the editing process corresponding to the included editing icon image, the transmitting process corresponding to the included transmission icon image, and the printing process corresponding to the included printing icon image in a row.

Details of the multi-processing icon displayed in the third embodiment are explained next. FIG. 30 is a schematic diagram for explaining one example of the configuration of the multi-processing icon displayed on the digital camera. The multi-processing icon 516 is an icon including the transmission icon image, the display icon image, and the saving icon image, for performing the transmitting process of transmitting the image data from the digital camera 750 to the PC 800 via the network, the display process in which the projector 900 receives edited data obtained by editing the image data by the PC 800 and displays the received edited data, and the saving process of saving the edited data obtained by editing the image data by the PC 800 on a CD-R, upon reception of a selection instruction thereof from the user. As shown in FIG. 30, in the multi-processing icon 516, a processing icon 517 indicates the transmitting process of the edited data by the edited data obtained by photographing a subject and editing the image by the digital camera and arrows directed toward the projector and the CD-R, a processing icon 518 indicates the display process of the edited data by the projector, and a processing icon 519 indicates the saving process of the edited data by the CD-R. The multi-processing icon 516 shows an example of the icon abstractly expressing the process, and the editing process of the image data actually performed by the PC is not displayed on the icon.

The digital camera 750 holds the process correspondence table as in the first embodiment shown in FIG. 2 on a storage medium such as a memory, and registers the key event, icon name, and processing contents of processes with respect to the multi-processing icon. In the example of the multi-processing icon shown in FIG. 30, as the processing content corresponding to the multi-processing icon, the transmitting process of the image data, a display-instruction transmitting process of the image data, and a saving-instruction transmitting process of the image data are registered. Because the image-data display process and the image-data saving process are not performed by the digital camera 750 side, the display-instruction transmitting process of the image data and the saving-instruction transmitting process of the image data are registered as the processing content in the process correspondence table.

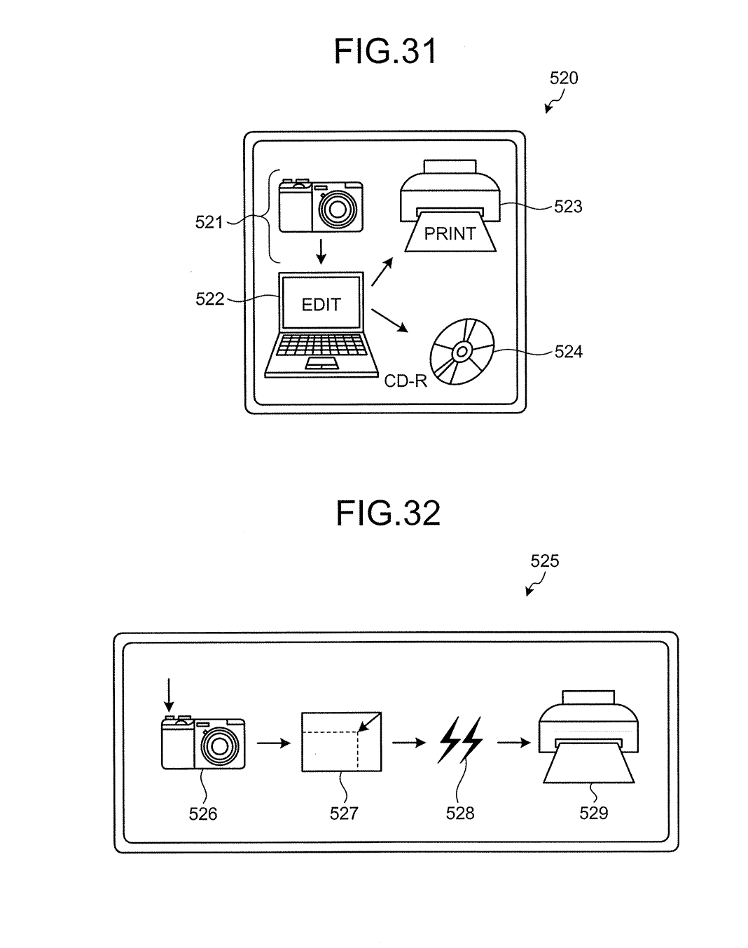

FIG. 31 is a schematic diagram for explaining another example of the configuration of the multi-processing icon displayed on the digital camera. A multi-processing icon 520 is an icon including the transmission icon image, the editing icon image, the printing icon image, and the saving icon image, for performing the transmitting process of transmitting the image data from the digital camera 750 to the PC 800 via the network, the editing process of editing the image data by the PC 800, the printing process of receiving and printing the edited data by the printer 902, and the saving process of saving the edited data by the PC 800 on a CD-R, upon reception of a selection instruction thereof from the user. As shown in FIG. 31, in the multi-processing icon 520, a processing icon 521 indicates the transmitting process of image data by the image data imaged by the digital camera and an arrow directed toward the PC, a processing icon 522 indicates the editing process by the PC, a processing icon 523 indicates the printing process of the edited data by the printer, and a processing icon 524 indicates the saving process of the edited data by the CD-R. The multi-processing icon 520 shows an example of the icon expressed by the device that performs the process.

In the example of the multi-processing icon shown in FIG. 31, as the processing content corresponding to the multi-processing icon, the image-data transmitting process, an editing-instruction transmitting process of the image data, a printing-instruction transmitting process of the image data, and the saving-instruction transmitting process of the image data are registered. Because the image-data editing process, the image-data printing process, and the image-data saving process are not performed by the digital camera 750 side, the editing-instruction transmitting process of the image data, the printing-instruction transmitting process of the image data, and the saving-instruction transmitting process of the image data are registered as the processing content in the process correspondence table.

FIG. 32 is a schematic diagram for explaining another example of the configuration of the multi-processing icon displayed on the digital camera. The multi-processing icon 525 is an icon including the editing icon image, the transmission icon image, and the printing icon image for performing the editing process of editing the image data by the digital camera 750, the transmitting process of transmitting the edited data to the printer 902, and the printing process of receiving and printing the edited data by the printer 902, upon reception of a selection instruction thereof from the user. As shown in FIG. 32, in the multi-processing icon 525, a processing icon 526 indicates the digital camera 750, a processing icon 527 indicates the editing process of the image data imaged by the digital camera, a processing icon 528 indicates the transmitting process of the edited data from the digital camera to the PC, and a processing icon 529 indicates the printing process of the edited data by the printer. The multi-processing icon 525 shows an example of the icon expressed by the process in detailed processing.

In the example of the multi-processing icon shown in FIG. 32, as the processing content corresponding to the multi-processing icon, an image-data editing process, the image-data transmitting process, and the printing-instruction transmitting process of the image data are registered. Because the image-data printing process is not performed by the digital camera 750 side, the printing-instruction transmitting process of the image data is registered as the processing content in the process correspondence table.

The input receiving unit 762 receives a display instruction and the like of various screens from the user. The input receiving unit 762 further receives a specification input of image data desired by the user and a selection input of the multi-processing icon.

The image processing unit 763 performs image processing with respect to an image of a subject imaged by the imaging unit 753 to generate image data, and stores the generated image data in the external memory 756.

The data editing unit 766 edits the image data generated by the image processing unit 763 to data suitable for printing and display, thereby generating the edited data.

Upon reception of a selection input of the multi-processing icon by the input receiving unit 762, the execution controller 765 controls respective components to perform the process corresponding to the processing icon image included in the received multi-processing icon. Specifically, for example, when the input receiving unit 762 receives a specification input of image data and a selection input of a multi-processing icon including the transmission icon image, the display icon image, and the saving icon image (see FIG. 30), the execution controller 765 controls the transmitting and receiving unit 764 to transmit the specified image data, a display instruction for performing the display process corresponding to the display icon image, and a saving instruction for performing the saving process corresponding to the saving icon image, to the PC 800 as the transmitting process corresponding to the transmission icon image included in the received multi-processing icon.

For example, when the input receiving unit 762 receives a specification input of image data and a selection input of a multi-processing icon including the transmission icon image, the editing icon image, the printing icon image, and the saving icon image (see FIG. 31), the execution controller 765 controls the transmitting and receiving unit 764 to transmit the specified image data, an editing instruction for performing the editing process corresponding to the editing icon image, a printing instruction for performing the printing process corresponding to the printing icon image, and a saving instruction for performing the saving process corresponding to the saving icon image, to the PC 800 as the transmitting process corresponding to the transmission icon image included in the received multi-processing icon.

Further, when the input receiving unit 762 receives a specification input of image data and a selection input of a multi-processing icon including the editing icon image, the transmission icon image, and the printing icon image (see FIG. 32), the execution controller 765 edits the specified image data as the editing process corresponding to the editing icon image included in the received multi-processing icon, and controls the transmitting and receiving unit 764 to transmit the edited data and a printing instruction for performing the printing process corresponding to the printing icon image to the printer 902 as the transmitting process corresponding to the transmission icon image included in the received multi-processing icon.

The transmitting and receiving unit 764 performs the transmitting process corresponding to the transmission icon. For example, the transmitting and receiving unit 764 performs the transmitting process of transmitting the image data, the display instruction, and the saving instruction; the transmitting process of transmitting the image data, the editing instruction, the printing instruction, and the saving instruction; or the transmitting process of transmitting the edited data and the printing instruction.

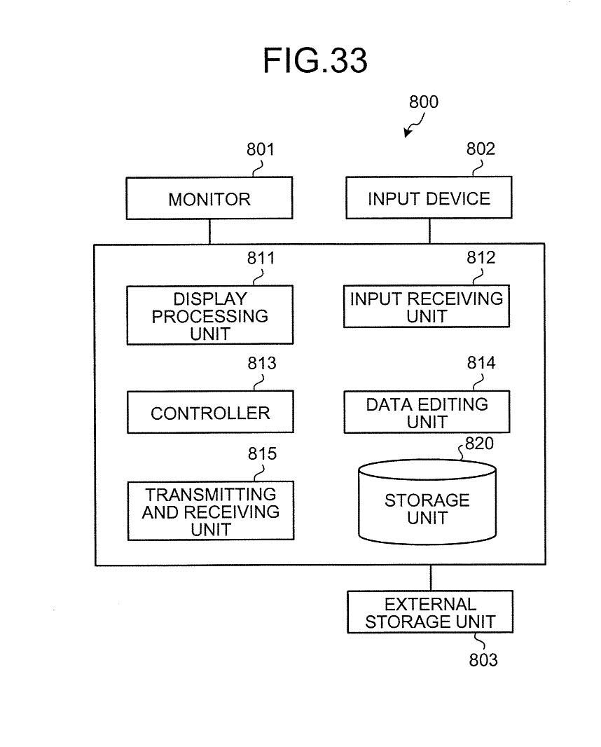

Details of the PC 800 are explained next. FIG. 33 is a functional block diagram of the PC according to the third embodiment. As shown in FIG. 33, the PC 800 mainly includes a monitor 801, an input device 802, an external storage unit 803, a storage unit 820, a display processing unit 811, an input receiving unit 812, a controller 813, a data editing unit 814, and a transmitting and receiving unit 815.

The monitor 801 is a display device that displays characters and images. The input device 802 is, for example, a pointing device such as a mouse, a trackball, or a trackpad, and a keyboard, for the user to perform an operation with respect to the screen displayed on the monitor 801. The external storage unit 803 is a CD-R or the like for storing imaged data and edited data.

The storage unit 820 is a storage medium such as an HDD or a memory for storing various data.

The display processing unit 811 displays various data and screens on the monitor 801.

The input receiving unit 812 receives an input with respect to the screen displayed on the monitor 801 by the user who operates the input device 802.

The controller 813 controls respective components according to the input received by the input receiving unit 812.

When the transmitting and receiving unit 815 receives image data, a display instruction, and a saving instruction from the digital camera 750, the data editing unit 814 edits the image data to data displayable by the projector 900 or storable on the CD-R or the like to generate edited data, and stores the generated edited data in the storage unit 820 or the CD-R or the like, which is the external storage medium. Further, when the transmitting and receiving unit 815 receives image data, an editing instruction, a printing instruction, and a saving instruction from the digital camera 750, the data editing unit 814 edits the image data to data printable by the printer 902 or storable on the CD-R or the like to generate edited data, and stores the generated edited data in the storage unit 820 or the CR-R or the like, which is the external storage medium.

The transmitting and receiving unit 815 transmits and receives various data. For example, the transmitting and receiving unit 815 receives the image data specified by the user, the display instruction, and the saving instruction from the digital camera 750, and transmits edited data edited by the data editing unit 814 and the display instruction to the projector 900. For example, the transmitting and receiving unit 815 receives the image data specified by the user, the editing instruction, the printing instruction, and the saving instruction from the digital camera 750, and transmits edited data edited by the data editing unit 814 and the printing instruction to the printer 902.

The projector 900 in FIG. 28 is explained next. The projector 900 is an apparatus that displays data such as images, and includes a receiving unit (not shown) that receives the edited data and the display instruction from the PC 800. The projector 900 also includes a display processing unit (not shown) that, when the receiving unit receives the edited data and the display instruction, performs the display process of displaying the edited data on the display unit (not shown) according to the received display instruction. Other components are the same as known projectors, and therefore explanations thereof will be omitted.

The printer 902 in FIG. 28 is explained. The printer 902 is an apparatus that prints data such as images, and includes a receiving unit (not shown) that receives the edited data and the printing instruction from the PC 800 or the digital camera 750. The printer 902 also includes a printing processing unit (not shown) that, when the receiving unit receives the edited data and the printing instruction, performs the printing process of the edited data according to the received printing instruction. Other components are the same as known printers, and therefore explanations thereof will be omitted.

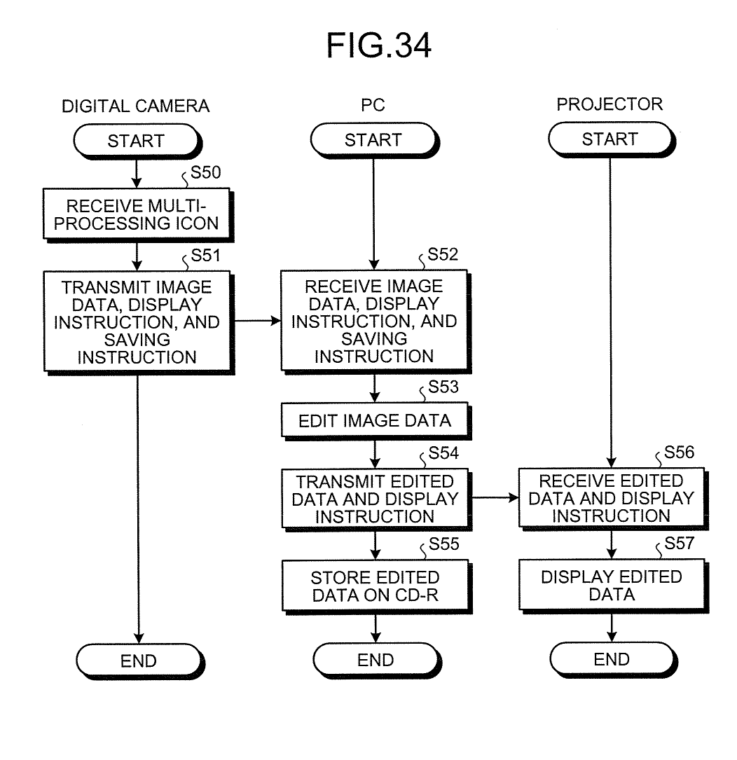

The display executing process performed by the digital camera 750, the PC 800, the projector 900, and the like according to the third embodiment is explained next. FIG. 34 is a flowchart of an overall flow of the display executing process in the third embodiment. A process performed by the digital camera 750, the PC 800, and the projector 900 is explained, using the icon explained with reference to FIG. 30 as the multi-processing icon. The display process of the multi-processing icon in the digital camera 750 is controlled as described below by the execution controller 765.

The input receiving unit 762 in the digital camera 750 receives a specification input of image data desired to be displayed by the projector 900 and a multi-processing icon (see FIG. 30) from the user (Step S50). The transmitting and receiving unit 764 transmits the image data received by the input receiving unit 762, a display instruction for performing the display process corresponding to the display icon image, and a saving instruction for performing the saving process corresponding to the saving icon image to the PC 800 as the transmitting process corresponding to the transmission icon image included in the received multi-processing icon (Step S51). At this time, the editing instruction for performing the editing process can be transmitted at the same time.

The transmitting and receiving unit 815 in the PC 800 receives the image data, the display instruction, and the saving instruction from the digital camera 750 (Step S52). Upon reception of the image data, the display instruction, and the saving instruction, the data editing unit 814 edits the image data to data displayable by the projector 900 or storable on the CD-R or the like to generate edited data (Step S53). The transmitting and receiving unit 815 then transmits the edited data edited by the data editing unit 814 and the display instruction to the projector 900 (Step S54). The data editing unit 814 stores the generated edited data on the CD-R (Step S55).

The receiving unit in the projector 900 receives the edited data and the display instruction from the PC 800 (Step S56). The display processing unit displays the edited data on the display unit according to the received display instruction (Step S57).

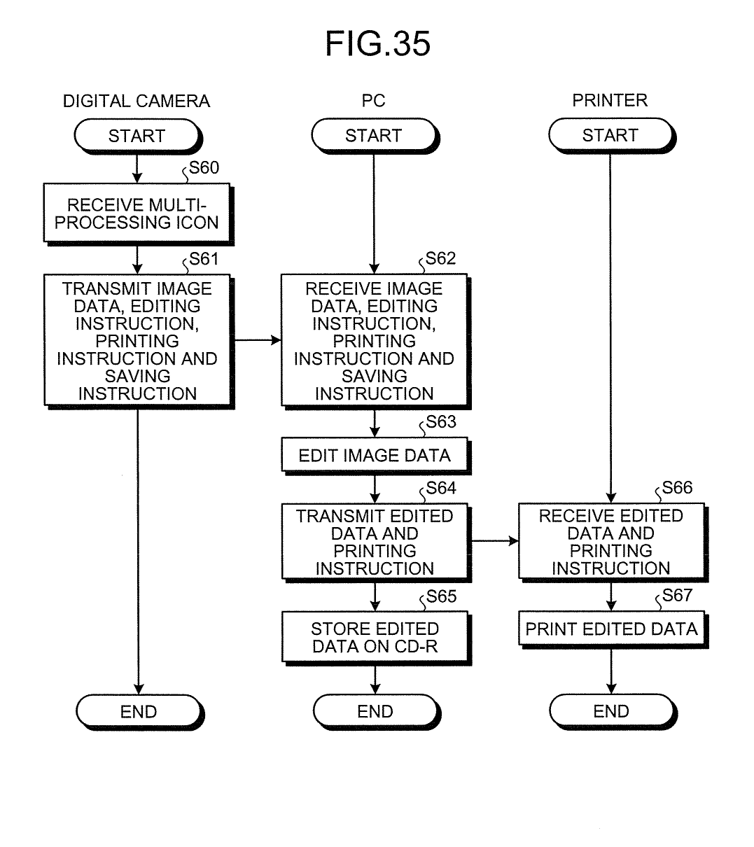

The display executing process performed by the digital camera 750, the PC 800, and the printer 902 according to the third embodiment is explained next. FIG. 35 is a flowchart of an overall flow of the display executing process in the third embodiment. A process performed by the digital camera 750, the PC 800, and the printer 902 is explained, using the icon explained with reference to FIG. 31 as the multi-processing icon. The display process of the multi-processing icon in the digital camera 750 is controlled as described below by the execution controller 765.

The input receiving unit 762 in the digital camera 750 receives a specification input of image data desired to be printed by the printer 902 and a multi-processing icon (see FIG. 31) from the user (Step S60). The transmitting and receiving unit 764 transmits the image data received by the input receiving unit 762, an editing instruction for performing the editing process corresponding to the editing icon image, a printing instruction for performing the printing process corresponding to the printing icon image, and a saving instruction for performing the saving process corresponding to the saving icon image to the PC 800 as the transmitting process corresponding to the transmission icon image included in the received multi-processing icon (Step S61).

The transmitting and receiving unit 815 in the PC 800 receives the image data, the editing instruction, the printing instruction, and the saving instruction from the digital camera 750 (Step S62). Upon reception of the image data, the editing instruction, the printing instruction, and the saving instruction, the data editing unit 814 edits the image data to data printable by the printer 902 or storable on the CD-R or the like according to the editing instruction, to generate edited data (Step S63). The transmitting and receiving unit 815 then transmits the edited data edited by the data editing unit 814 and the printing instruction to the printer 902 (Step S64). The data editing unit 814 stores the generated edited data on the CD-R (Step S65).

The receiving unit in the printer 902 receives the edited data and the printing instruction from the PC 800 (Step S66). The printing processing unit prints the edited data according to the received printing instruction (Step S67).

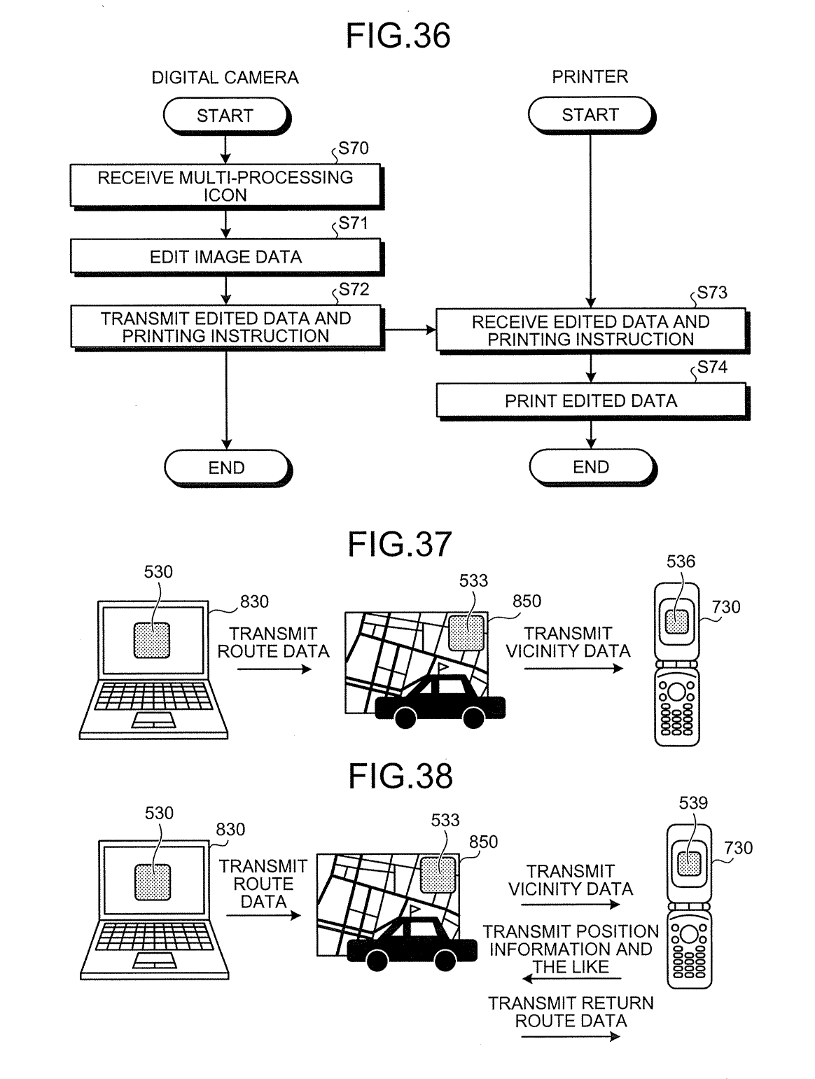

The display executing process performed by the digital camera 750 and the printer 902 according to the third embodiment is explained next. FIG. 36 is a flowchart of an overall flow of the display executing process in the third embodiment. A process performed by the digital camera 750 and the printer 902 is explained, using the icon explained with reference to FIG. 32 as the multi-processing icon. The display process of the multi-processing icon in the digital camera 750 is controlled as described below by the execution controller 765.

The input receiving unit 762 in the digital camera 750 receives a specification input of image data desired to be printed by the printer 902 and a multi-processing icon (see FIG. 32) from the user (Step S70). The data editing unit 766 edits the image data printable by the printer 902 to generate the edited data (Step S71). The transmitting and receiving unit 764 transmits the edited data edited by the data editing unit 766 and a printing instruction for performing the printing process corresponding to the printing icon image to the printer 902 as the transmitting process corresponding to the transmission icon image included in the received multi-processing icon (Step S72).

The receiving unit in the printer 902 receives the edited data and the printing instruction from the digital camera 750 (Step S73). The printing processing unit prints the edited data according to the received printing instruction (Step S74).

Thus, in the digital camera 750, the PC 800, and the projector 900 according to the third embodiment, upon reception of a selection input of the multi-processing icon after a subject is imaged by the digital camera 750, the image data, the display instruction, and the printing instruction are transmitted to the PC 800, and the edited data edited by the PC 800 is displayed by the projector 900 or printed by the printer 902. Further, upon reception of a selection input of the multi-processing icon after a subject is imaged by the digital camera 750, the image data is edited, and the edited data is transmitted to the printer 902 to be printed out. Therefore, processes in different devices can be selected and performed simultaneously by receiving the selection input of the multi-processing icon concisely indicating processing contents, thereby enabling to simplify the operation procedure and improve the operability at the time of performing the processes simultaneously or in a row. Further, by displaying the input icon image corresponding to the input process and the output icon image corresponding to the output process on the LCD 751, the processing contents to be executed can be easily ascertained, and an operational error can be prevented by receiving a selection input of processes by the multi-processing icon. Further, because multi-processing can be easily performed between a plurality of devices, the image imaged by the digital camera 750 can be easily displayed or printed out. Accordingly, the image can be easily confirmed or received.

In the third embodiment, the multi-processing icon of processes executed by the digital camera, the PC, the projector, and the like is displayed to perform the processes by the respective devices. However, in a fourth embodiment of the present invention, a multi-processing icon of processes executed by the PC, the car navigation system, the mobile phone, and the like is displayed to perform the processes by the respective devices.

An outline of processes performed by the PC, the car navigation system, and the mobile phone according to the fourth embodiment is explained with reference to the drawings. FIGS. 37 to 39 are schematic diagrams for explaining an outline of processes performed by the PC, the car navigation system, and the mobile phone according to the fourth embodiment.

As shown in FIG. 37, in the fourth embodiment, when a route to a destination is acquired by a PC 830 and a selection input of a multi-processing icon 530 (described later) is received from the user, data of the acquired route (route data) is transmitted from the PC 830 to a car navigation system 850, and the car navigation system 850 displays the route data to perform navigation. When vicinity information of a destination is searched by the car navigation system 850 and a selection input of a multi-processing icon 533 (described later) is received from the user, data of the searched vicinity information (vicinity data) is transmitted from the car navigation system 850 to a mobile phone 730, and the mobile phone 730 displays the vicinity data to perform navigation. Upon reception of a selection input of a multi-processing icon 536 (described later) from the user, the mobile phone 730 searches for a return route from the destination to a car and displays the searched return route data to perform navigation.

In other processes in the fourth embodiment, as shown in FIG. 38, the flow until display of the route data and the vicinity data is the same as that of the process shown in FIG. 37. Upon reception of a selection input of a multi-processing icon 539 (described later in detail) from the user, the mobile phone 730 transmits position information or the like of the mobile phone 730 to the car navigation system 850, the car navigation system 850 searches for the return route from the destination to the car to transmit data of the searched return route (return route data) to the mobile phone 730, and the mobile phone 730 displays the return route data to perform navigation.

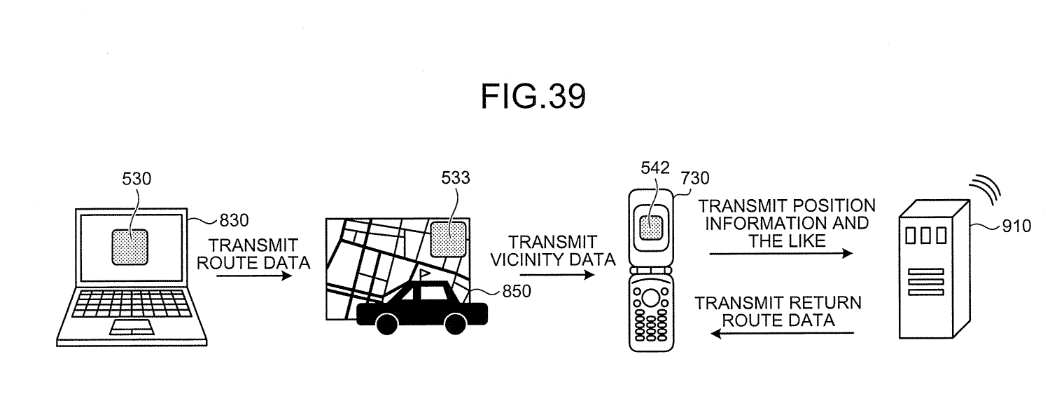

In other processes in the fourth embodiment, as shown in FIG. 39, the flow until display of the route data and the vicinity data is the same as that of the process shown in FIG. 37. Upon reception of a selection input of a multi-processing icon 542 (described later) from the user, the mobile phone 730 transmits the position information or the like of the mobile phone 730 to a server 910, the server 910 searches for the return route from the destination to the car to transmit data of the searched return route (return route data) to the mobile phone 730, and the mobile phone 730 displays the return route data to perform navigation.

The process in the fourth embodiment is used by displaying information desired according to the situation and place, such as the route information to the destination or shop information near the destination on a monitor of the PC, the car navigation system, or the mobile phone, for example, at the time of recreation.

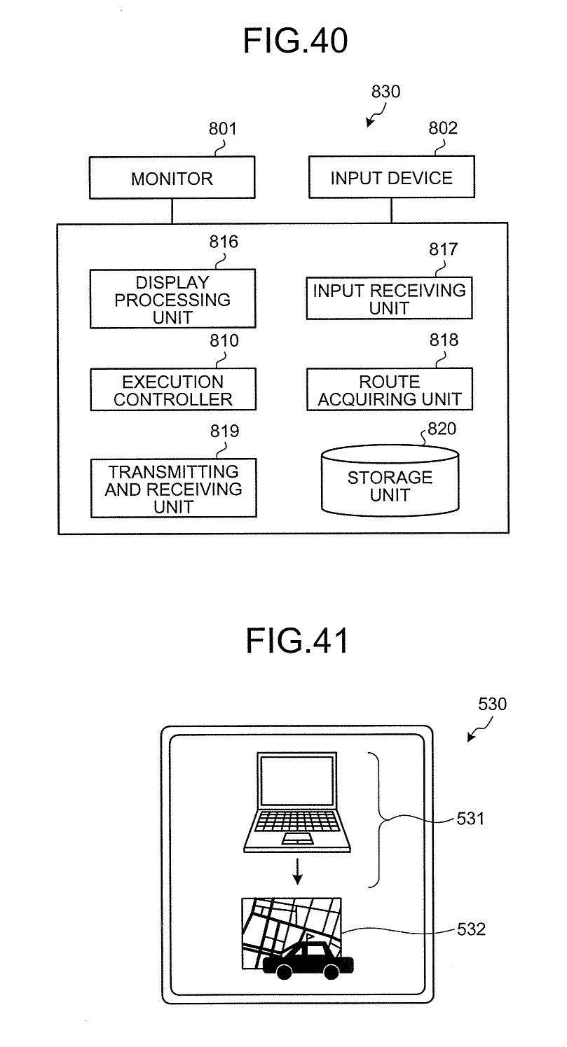

Details of the PC 830 are explained next. FIG. 40 is a functional block diagram of the PC according to the fourth embodiment. As shown in FIG. 40, the PC 830 mainly includes the monitor 801, the input device 802, the storage unit 820, a display processing unit 816, an input receiving unit 817, an execution controller 810, a route acquiring unit 818, and a transmitting and receiving unit 819. Because the monitor 801 and the input device 802 are the same as in the third embodiment, explanations thereof will be omitted.

The storage unit 820 is a storage medium such as an HDD or a memory that stores various data, for example, route data to the destination, the processing icon, and the multi-processing icons. The processing icon respectively corresponds to processes (input process and output process) by respective functions of the PC 830, the car navigation system 850, and the mobile phone 730, for giving a selection instruction of the process by respective functions. The multi-processing icons are icons including a plurality of processing icon images, for in a row performing processes corresponding to the included processing icon images in a row, when selected.

The route acquiring unit 818 acquires route data indicating a route to a destination such as a ski resort via a network.

The display processing unit 816 displays various data and screens on the monitor 801. The display processing unit 816 also displays the processing icon and the multi-processing icon. Specifically, for example, the display processing unit 816 displays, on the monitor 801, a multi-processing icon including an image of the transmission icon (transmission icon image) corresponding to the transmitting process performed by the PC 830 and an image of the display icon (display icon image) corresponding to the display process performed by the car navigation system 850, for giving a selection instruction to in a row perform the transmitting process corresponding to the included transmission icon image and the display process corresponding to the included display icon image.

Details of the multi-processing icon displayed on a monitor of the PC 830 according to the fourth embodiment are explained. FIG. 41 is a schematic diagram for explaining one example of the configuration of the multi-processing icon displayed on a monitor of the PC 830. The multi-processing icon 530 is an icon including the transmission icon image and the display icon image for performing the transmitting process of transmitting the route data from the PC 830 to the car navigation system 850 via the network and the display process of displaying the route data on the car navigation system 850, upon reception of a selection instruction thereof from the user. As shown in FIG. 41, in the multi-processing icon 530, a processing icon 531 indicates the transmitting process of the route data by the PC and an arrow directed from the PC toward the car navigation system, and a processing icon 532 indicates the display process of the route data by the car navigation system.

The PC 830 holds the process correspondence table as in the first embodiment shown in FIG. 2 on a storage medium such as a memory, and registers the key event, icon name, and processing contents of a plurality of processes with respect to the multi-processing icon. In the example of the multi-processing icon, as the processing content corresponding to the multi-processing icon, the transmitting process and the display-instruction transmitting process are registered.

The input receiving unit 817 receives an input with respect to the screen displayed on the monitor 801 by the user who operates the input device 802. The input receiving unit 817 receives a specification input of the route data desired by the user and a selection input of the multi-processing icon.

Upon reception of the selection input of the multi-processing icon by the input receiving unit 817, the execution controller 810 controls the respective components to perform the process corresponding to the processing icon image included in the received multi-processing icon. Specifically, for example, when the input receiving unit 817 receives a specification input of the route data and a selection input of a multi-processing icon including the transmission icon image and the display icon image (see FIG. 41), the execution controller 810 controls the transmitting and receiving unit 819 to transmit the specified route data and the display instruction for performing the display process corresponding to the display icon image to the car navigation system 850, as the transmitting process corresponding to the transmission icon image included in the received multi-processing icon.

The transmitting and receiving unit 819 transmits and receives various data and the like, and performs the transmitting process corresponding to the transmission icon. For example, the transmitting and receiving unit 819 performs the transmitting process of transmitting the route data and the display instruction as the transmitting process.

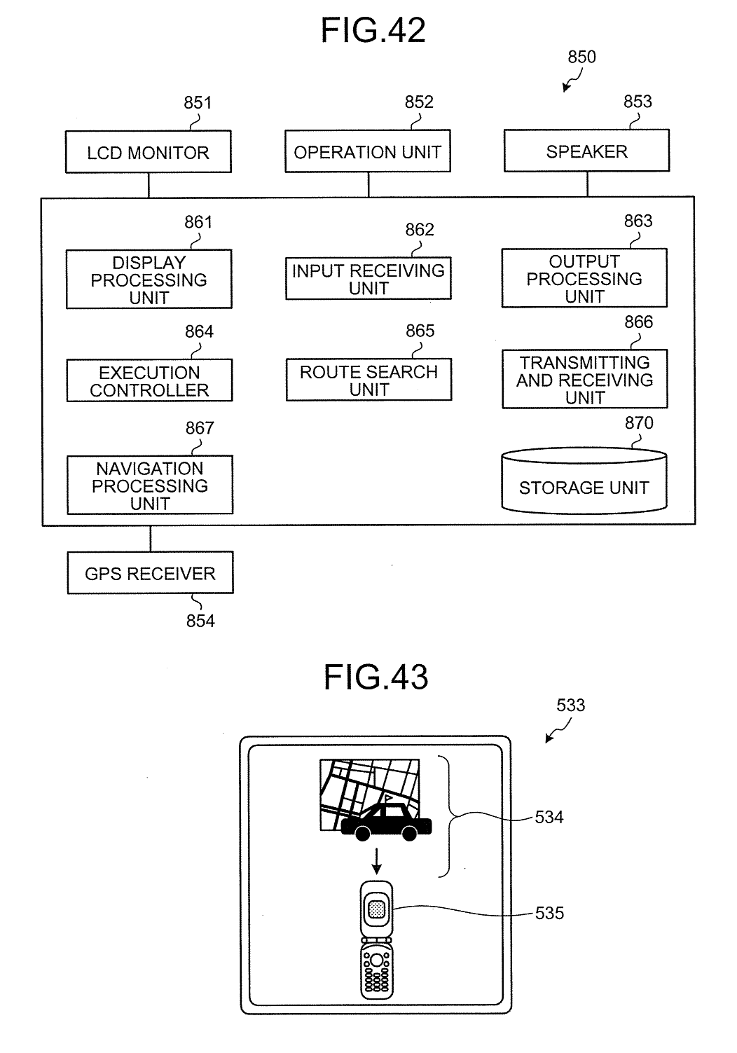

Details of the car navigation system 850 are explained next. FIG. 42 is a functional block diagram of the car navigation system according to the fourth embodiment. As shown in FIG. 42, the car navigation system 850 mainly includes an LCD monitor 851, an operation unit 852, a speaker 853, a GPS receiver 854, a storage unit 870, a display processing unit 861, an input receiving unit 862, an output processing unit 863, an execution controller 864, a route search unit 865, a transmitting and receiving unit 866, and a navigation processing unit 867.

The LCD monitor 851 is a display device that displays characters and images, and displays, for example, the route data to the destination. The operation unit 852 inputs data by a key, a button, or the like. The speaker 853 outputs voice data. The GPS receiver 854 receives a position (latitude/longitude or the like) of the car navigation system 850 on the earth.

The storage unit 870 is a storage medium such as a memory that stores various data, for example, route data to the destination or vicinity data thereof, return route data, the processing icon, and the multi-processing icon.

The route search unit 865 searches for the vicinity information of the destination, for example, a shop or public facilities, to generate the vicinity data, which is data of the vicinity information, and stores the generated vicinity data in the storage unit 870. Upon reception of the position information of the mobile phone 730 and a search instruction by the transmitting and receiving unit 866 (described later), the route search unit 865 searches for the return route from the mobile phone 730 to the car navigation system 850 to generate the return route data, and stores the generated return route data in the storage unit 870.

The display processing unit 861 displays various data and screens on the LCD monitor 851. The display processing unit 861 displays the processing icon and the multi-processing icon. When the transmitting and receiving unit 866 (described later) receives the route data and a display instruction, the display processing unit 861 performs the display process of displaying the route data on the LCD monitor 851. For example, the display processing unit 861 includes an image of the transmission icon (transmission icon image) corresponding to the transmitting process performed by the car navigation system 850 and an image of the display icon (display icon image) corresponding to the display process performed by the mobile phone 730, and displays a multi-processing icon for giving a selection instruction to in a row perform the transmitting process corresponding to the included transmission icon image and the display process corresponding to the included display icon image, on the LCD monitor 851.

Details of the multi-processing icon displayed on the car navigation system 850 in the fourth embodiment are explained next. FIG. 43 is a schematic diagram for explaining one example of the configuration of the multi-processing icon displayed on the car navigation system. The multi-processing icon 533 includes the transfer icon image and the display icon image, for performing the transmitting process of transmitting the vicinity data from the car navigation system 850 to the mobile phone 730 via the network and the display process of displaying the vicinity data on the mobile phone 730, upon reception of a selection instruction thereof from the user. As shown in FIG. 43, in the multi-processing icon 533, a processing icon 534 indicates the transmitting process of the route data by the car navigation system and an arrow from the car navigation system to the mobile phone, and a processing icon 535 indicates the display process of the vicinity data by the mobile phone.

The car navigation system 850 holds the process correspondence table as in the first embodiment shown in FIG. 2 on a storage medium such as a memory, and registers the key event, icon name, and processing contents of processes with respect to the multi-processing icon. In the example of the multi-processing icon, as the processing content corresponding to the multi-processing icon, a vicinity-data transmitting process and a vicinity-data display-instruction transmitting process are registered.

The input receiving unit 862 receives an input with respect to the screen displayed on the LCD monitor 851 by the user who operates the operation unit 852. The input receiving unit 862 receives a specification input of the vicinity data desired by the user and a selection input of the multi-processing icon.

The navigation processing unit 867 navigates the route to the destination based on the route data displayed on the LCD monitor 851 by the display processing unit 861.

The output processing unit 863 outputs the navigation result performed by the navigation processing unit 867 as a speech from the speaker 853.

Upon reception of the selection input of the multi-processing icon by the input receiving unit 862, the execution controller 864 controls the respective components to perform the process corresponding to the processing icon image included in the received multi-processing icon. Specifically, for example, when the input receiving unit 862 receives a specification input of the vicinity data and a selection input of a multi-processing icon including the transmission icon image and the display icon image (see FIG. 43), the execution controller 864 controls the transmitting and receiving unit 866 described later to transmit the specified vicinity data and a display instruction for performing the display process corresponding to the display icon image to the mobile phone 730, as the transmitting process corresponding to the transmission icon image included in the received multi-processing icon.

The transmitting and receiving unit 866 transmits and receives various data and the like, and then receives the route data specified by the user and the display instruction from the PC 830. Further, the transmitting and receiving unit 866 performs the transmitting process corresponding to the transmission icon, and for example as the transmitting process, performs the transmitting process of transmitting the vicinity data and the display instruction. The transmitting and receiving unit 866 also receives the position information of the mobile phone 730, the search instruction, and the display instruction from the mobile phone 730 and transmits the return route data searched by the route search unit 865 and the display instruction to the mobile phone 730.

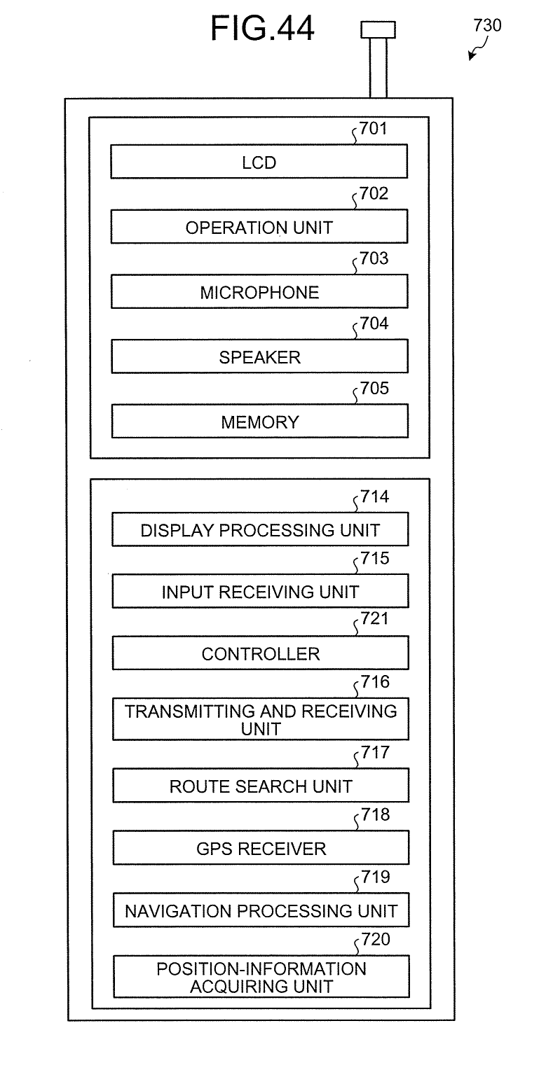

Details of the mobile phone 730 are explained next. FIG. 44 is a functional block diagram of the mobile phone according to the fourth embodiment. As shown in FIG. 44, the mobile phone 730 mainly includes the LCD 701, the operation unit 702, the microphone 703, the speaker 704, the memory 705, a display processing unit 714, an input receiving unit 715, a controller 721, a transmitting and receiving unit 716, a route search unit 717, a GPS receiver 718, a navigation processing unit 719, and a position-information acquiring unit 720. Because the LCD 701, the operation unit 702, the microphone 703, and the speaker 704 are the same as those in the second embodiment, explanations thereof will be omitted.

The memory 705 stores the processing icon, the multi-processing icon, the vicinity data, and the return route data.

The display processing unit 714 displays various data and screens to be transferred on the LCD 701. Specifically, for example, upon reception of the vicinity data specified by the user and the display instruction by the transmitting and receiving unit 716 (described later), the display processing unit 714 displays the vicinity data on the LCD 701 according to the received display instruction.

The display processing unit 714 also displays the processing icon and the multi-processing icon. Specifically, for example, the display processing unit 714 displays, on the LCD 701, a multi-processing icon including an image of the return-route search icon (return-route search icon image) corresponding to a return-route search process performed by the mobile phone 730 and an image of a return route display icon (return route display icon image) corresponding to a return route display process performed by the mobile phone 730, for giving a selection instruction to in a row perform the return-route search process corresponding to the included return-route search icon image and the return route display process corresponding to the included return route display icon image. When the input receiving unit 715 receives a selection input of the multi-processing icon including the return-route search icon image and the return route display icon image, the display processing unit 714 displays the return route data on the LCD 701, as the return route display process corresponding to the return route display icon image.

The display processing unit 714 further displays, on the LCD 701, a multi-processing icon including the return-route search icon image corresponding to the return-route search process performed by the car navigation system 850 and the return route display icon image corresponding to the return route display process performed by the mobile phone 730, for giving a selection instruction to in a row perform the return-route search process corresponding to the included return-route search icon image and the return route display process corresponding to the included return route display icon image. When the input receiving unit 715 receives a selection input of the multi-processing icon including the return-route search icon image and the return route display icon image, the display processing unit 714 displays the return route data received from the car navigation system 850 on the LCD 701, as the return route display process corresponding to the return route display icon image.

Further, the display processing unit 714 displays, on the LCD 701, a multi-processing icon including the return-route search icon image corresponding to the return-route search process performed by the server 910 and the return route display icon image corresponding to the return route display process performed by the mobile phone 730, for giving a selection instruction to in a row perform the return-route search process corresponding to the included return-route search icon image and the return route display process corresponding to the included return route display icon image. When the input receiving unit 715 receives a selection input of the multi-processing icon including the return-route search icon image and the return route display icon image, the display processing unit 714 displays the return route data received from the server 910 as the return route display process corresponding to the return route display icon image, on the LCD 701. The server 910 transmits the return route data generated by searching for the return route from the mobile phone 730 to the car navigation system 850, to the mobile phone 730.

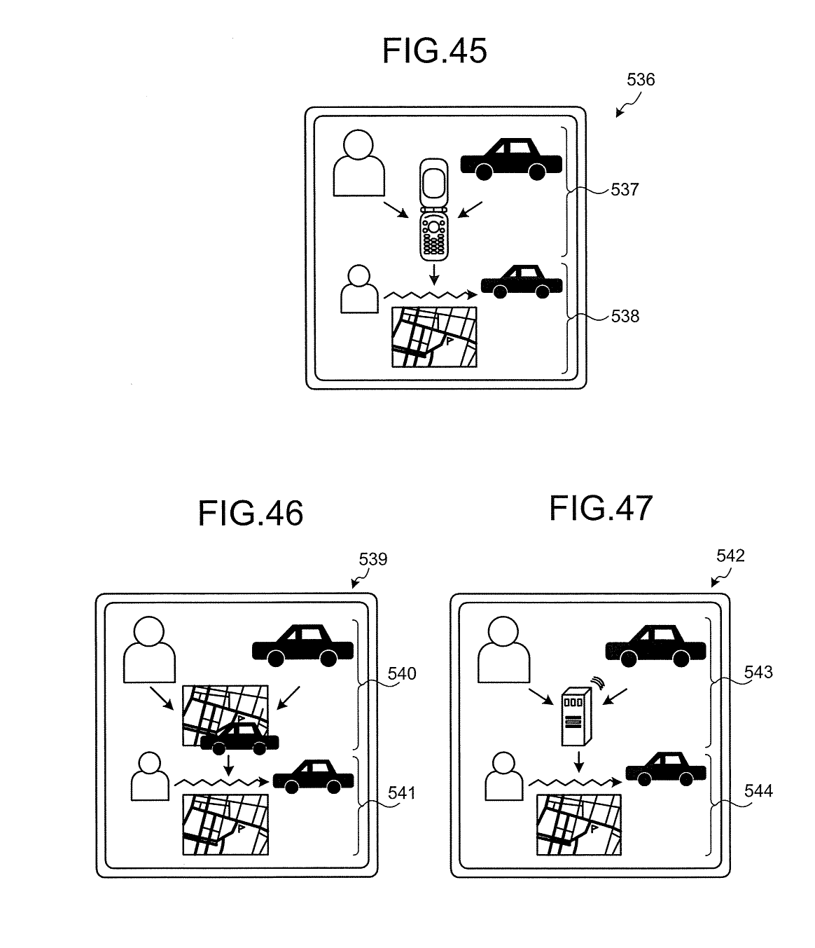

Details of the multi-processing icon displayed on the mobile phone 730 according to the fourth embodiment are explained. FIG. 45 is a schematic diagram for explaining one example of the configuration of the multi-processing icon displayed on the mobile phone. The multi-processing icon 536 is an icon including the return-route search icon image and the return route display icon image, for performing the return-route search process of searching the return route data by the mobile phone 739 and the return route display process of displaying the return route data by the mobile phone 730, upon reception of a selection instruction thereof from the user. As shown in FIG. 45, in the multi-processing icon 536, a processing icon 537 indicates a return-route search-instruction transmitting process of the return route data by the user, the car, and the mobile phone, and a processing icon 538 indicates the display process of the return route data by the mobile phone.

The mobile phone 730 holds the process correspondence table as in the first embodiment shown in FIG. 2 on a storage medium such as a memory, and registers the key event, icon name, and processing contents of processes with respect to the multi-processing icon. In the example of the multi-processing icon shown in FIG. 45, as the processing content corresponding to the multi-processing icon, the return-route search process and the return-route search-instruction transmitting process are registered in the process correspondence table.

Details of other multi-processing icon to be displayed on the mobile phone 730 according to the fourth embodiment are explained. FIG. 46 is a schematic diagram for explaining one example of the configuration of the multi-processing icon displayed on the mobile phone. The multi-processing icon 539 is an icon including the return-route search icon image and the return route display icon image for performing the return-route search process of searching for the return route data by the car navigation system 850 and the return route display process of displaying the return route data by the mobile phone 730, upon reception of a selection instruction thereof from the user. As shown in FIG. 46, in the multi-processing icon 539, a processing icon 540 indicates the return-route search-instruction transmitting process of the return route data by the user, the car, and the car navigation system, and a processing icon 541 indicates the display process of the return route data by the mobile phone.

In an example of the multi-processing icon shown in FIG. 46, the return-route search-instruction transmitting process and the return route display process are in the process correspondence table, as the processing content corresponding to the multi-processing icon.

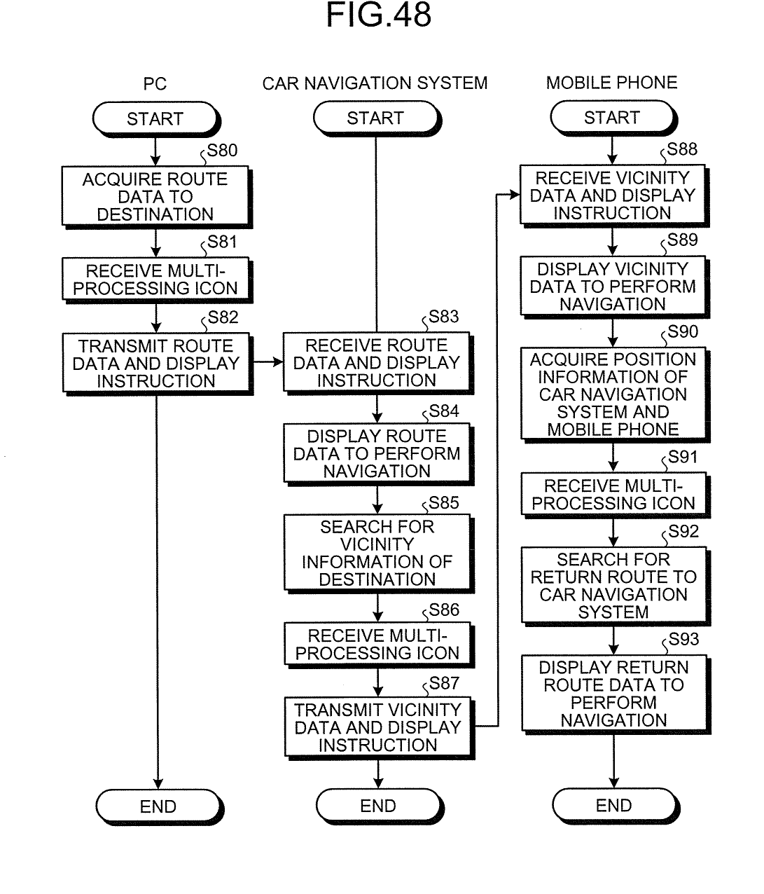

Details of another multi-processing icon to be displayed on the mobile phone 730 according to the fourth embodiment are explained. FIG. 47 is a schematic diagram for explaining one example of the configuration of the multi-processing icon displayed on the mobile phone. The multi-processing icon 542 is an icon including the return-route search icon image and the return route display icon image for performing the return-route search process of searching the return route data by the server 910 and the return route display process of displaying the return route data by the mobile phone 730, upon reception of a selection instruction thereof from the user. As shown in FIG. 47, in the multi-processing icon 542, a processing icon 543 indicates the return-route search-instruction transmitting process of the return route data by the user, the car, and the server, and a processing icon 544 indicates the display process of the return route data by the mobile phone.

In an example of the multi-processing icon in FIG. 47, the return-route search-instruction transmitting process and the return route display process are registered in the process correspondence table, as the processing content corresponding to the multi-processing icon.

The input receiving unit 715 receives transfer of messages, a display instruction of the various screens, and the like from the user. The input receiving unit 715 also receives a selection input of the multi-processing icon from the user.

The controller 721 controls the respective components according to an input received by the input receiving unit 715.

The transmitting and receiving unit 716 receives the vicinity data specified by the user and a display instruction from the car navigation system 850. When the input receiving unit 715 receives a selection input of the multi-processing icon including the return-route search icon image and the return route display icon image (see FIG. 46), the transmitting and receiving unit 716 transmits the position information of the mobile phone 730, a search instruction for searching for the return route data from the mobile phone 730 to the car navigation system 850, and a display instruction of the return route data to the car navigation system 850. The transmitting and receiving unit 716 receives the return route data and the display instruction from the car navigation system 850.

When the input receiving unit 715 receives a selection input of the multi-processing icon including the return-route search icon image and the return route display icon image (see FIG. 47), the transmitting and receiving unit 716 transmits the position information of the mobile phone 730, a search instruction for searching for the return route from the mobile phone 730 to the car navigation system 850, and a display instruction of the data of the return route (return route data) to the server 910, and receives the return route data and the display instruction from the server 910.

When the input receiving unit 715 receives the multi-processing icon including the return-route search icon image and the return route display icon image (see FIG. 45), the route search unit 717 searches for the return route from the mobile phone 730 to the car navigation system 850 based on the position information of the mobile phone 730 and the position information of the car navigation system 850, as the return-route search process corresponding to the return-route search icon image included in the received multi-processing icon, to generate the return route data, and stores the generated return route data in the memory 705.

The GPS receiver 718 receives radio waves from a GPS satellite at a certain time interval to receive the position (latitude/longitude or the like) of the mobile phone 730 on the earth.

The position-information acquiring unit 720 acquires by calculation position information indicating the position of the mobile phone 730 by latitude and longitude, based on the radio waves received by the GPS receiver 718, and sequentially stores the position information in the memory (not shown). The position-information acquiring unit also acquires the position information of the car navigation system 850 in the same manner.

The navigation processing unit 719 navigates the vicinity information of the destination based on the vicinity data displayed on the LCD 701 by the display processing unit 714. The navigation processing unit 719 also navigates the return route from the mobile phone 730 to the car navigation system 850 based on the return route data displayed on the LCD 701 by the display processing unit 714.

Details of the server 910 are explained next. The server 910 receives the position information of the mobile phone 730, the search instruction for searching for the return route from the mobile phone 730 to the car navigation system 850, and the display instruction of the return route data from the mobile phone 730, and searches for the return route from the mobile phone 730 to the car navigation system 850 to transmit the searched return route data and the display instruction to the mobile phone 730.

The display executing process performed by the PC 830, the car navigation system 850, and the mobile phone 730 according to the fourth embodiment is explained next. FIG. 48 is a flowchart of an overall flow of the display executing process in the fourth embodiment. A process performed by the PC 830, the car navigation system 850, and the mobile phone 730 is explained, using the icon explained with reference to FIGS. 41, 43, and 45 as the multi-processing icon. The display process of the multi-processing icon by the PC 830 is controlled by the execution controller 810 in the following manner, and the display process of the multi-processing icon by the car navigation system 850 is controlled by the execution controller 864 in the following manner.

In the PC 830, the route acquiring unit 818 acquires the route data to the destination, to which the user moves by a car mounting the car navigation system 850 thereon (Step S80). The input receiving unit 817 in the PC 830 receives a specification input of the route data desired to be displayed on the car navigation system 850 and the multi-processing icon including the transmission icon image and the display icon image (see FIG. 41) from the user (Step S81). The transmitting and receiving unit 819 transmits the route data received by the input receiving unit 817 and a display instruction for performing the display process corresponding to the display icon image to the car navigation system 850, as the transmitting process corresponding to the transmission icon image included in the received multi-processing icon (Step S82).

The transmitting and receiving unit 866 in the car navigation system 850 receives the route data and the display instruction from the PC 830 (Step S83). Upon reception of the route data and the display instruction, the display processing unit 861 displays the route data on the LCD monitor 851, and the navigation processing unit 867 navigates the route to the destination based on the route data displayed on the LCD monitor 851 (Step S84).

In the car navigation system 850, the route search unit 865 searches for the vicinity information of the destination to generate the vicinity data (Step S85). The input receiving unit 862 in the car navigation system 850 receives a specification input of the vicinity data desired to be displayed on the mobile phone 730 and the multi-processing icon including the transmission icon image and the display icon image (see FIG. 43) from the user (Step S86). The transmitting and receiving unit 866 transmits the vicinity data received by the input receiving unit 862 and the display instruction for performing the display process corresponding to the display icon image to the mobile phone 730, as the transmitting process corresponding to the transmission icon image included in the received multi-processing icon (Step S87).

The transmitting and receiving unit 716 in the mobile phone 730 receives the vicinity data and the display instruction from the car navigation system 850 (Step S88). Upon reception of the vicinity data and the display instruction, the display processing unit 714 displays the vicinity data on the LCD 701, and the navigation processing unit 719 navigates the vicinity information of the destination based on the vicinity data displayed on the LCD 701 (Step S89).

The position-information acquiring unit 720 in the mobile phone 730 acquires the position information of the car navigation system 850 and the mobile phone 730 (Step S90). The input receiving unit 715 receives the multi-processing icon including the return-route search icon image and the return route display icon image (see FIG. 45) from the user (Step S91).

Upon reception of the multi-processing icon, the route search unit 717 searches for the return route from the mobile phone 730 to the car navigation system 850 based on the position information of the mobile phone 730 and the car navigation system 850, as the return-route search process corresponding to the return-route search icon image included in the received multi-processing icon, to generate the return route data (Step S92). The display processing unit 714 displays the return route data on the LCD 701, and the display processing unit 714 navigates the return route to the car navigation system 850 (return route to the car) based on the return route data displayed on the LCD 701 (Step S93).

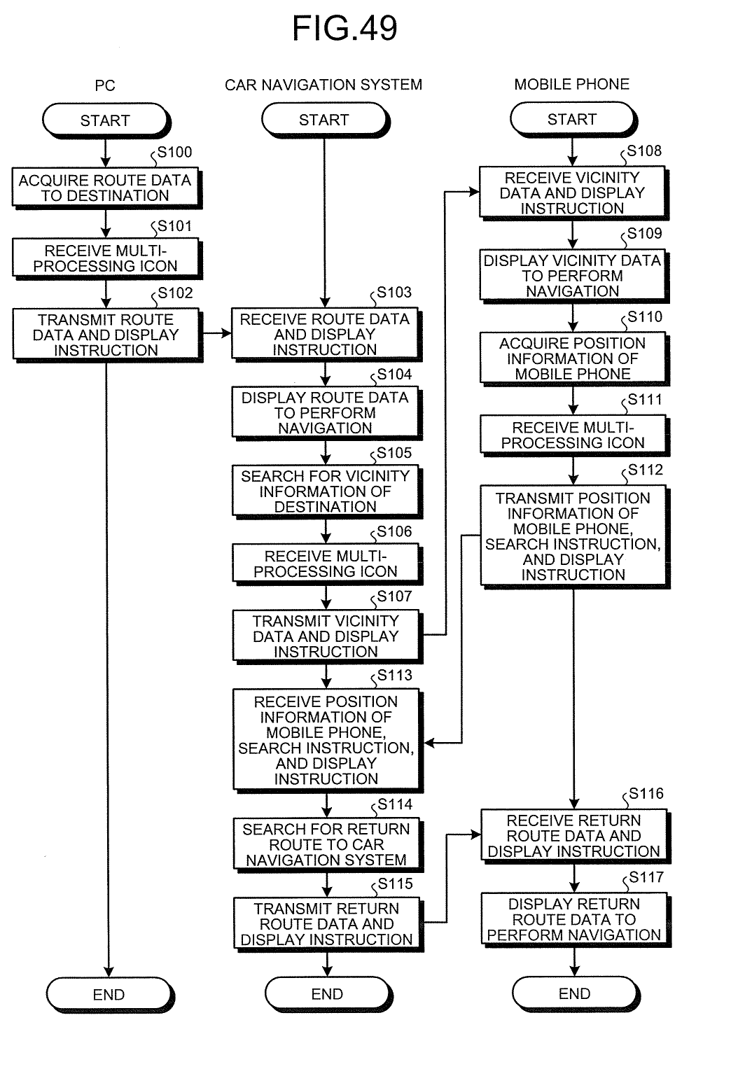

Anther display executing process performed by the PC 830, the car navigation system 850, and the mobile phone 730 according to the fourth embodiment is explained next. FIG. 49 is a flowchart of an overall flow of another display executing process in the fourth embodiment. A process performed by the PC 830, the car navigation system 850, and the mobile phone 730 is explained below, using the icon explained with reference to FIGS. 41, 43, and 46 as the multi-processing icon. The display process of the multi-processing icon by the PC 830 is controlled by the execution controller 810 in the following manner, and the display process of the multi-processing icon by the car navigation system 850 is controlled by the execution controller 864 in the following manner.

The process from acquisition of the route data by the route acquiring unit 818 in the PC 830 until display of the vicinity data by the display processing unit 714 in the mobile phone 730 and navigation performed by the navigation processing unit 719 (Steps S100 to S109) is the same as the process in FIG. 48 (Steps S80 to S89), and therefore explanations thereof will be omitted.

The position-information acquiring unit 720 in the mobile phone 730 acquires the position information of the mobile phone 730 (Step S110). The input receiving unit 715 receives the multi-processing icon including the return-route search icon image and the return route display icon image (see FIG. 46) from the user (Step S111).

Upon reception of the multi-processing icon, the transmitting and receiving unit 716 transmits the position information of the mobile phone 730, a search instruction for searching for the return route data from the mobile phone 730 to the car navigation system 850, and a display instruction of the return route data to the car navigation system 850 (Step S112).

The transmitting and receiving unit 866 in the car navigation system 850 receives the position information of the mobile phone 730, the search instruction of the return route data, and the display instruction of the return route data from the mobile phone 730 (Step S113). The route search unit 717 searches for the return route from the mobile phone 730 to the car navigation system 850 based on the received search instruction and the position information of the mobile phone 730, to generate the return route data (Step S114). The transmitting and receiving unit 866 transmits the searched return route data and the display instruction of the return route data to the mobile phone 730 (Step S115).

The transmitting and receiving unit 716 in the mobile phone 730 receives the return route data and the display instruction of the return route data from the car navigation system 850 (Step S116). The display processing unit 714 displays the return route data on the LCD 701, and the navigation processing unit 719 navigates the return route to the car navigation system 850 (return route to the car) based on the return route data displayed on the LCD 701 (Step S117).

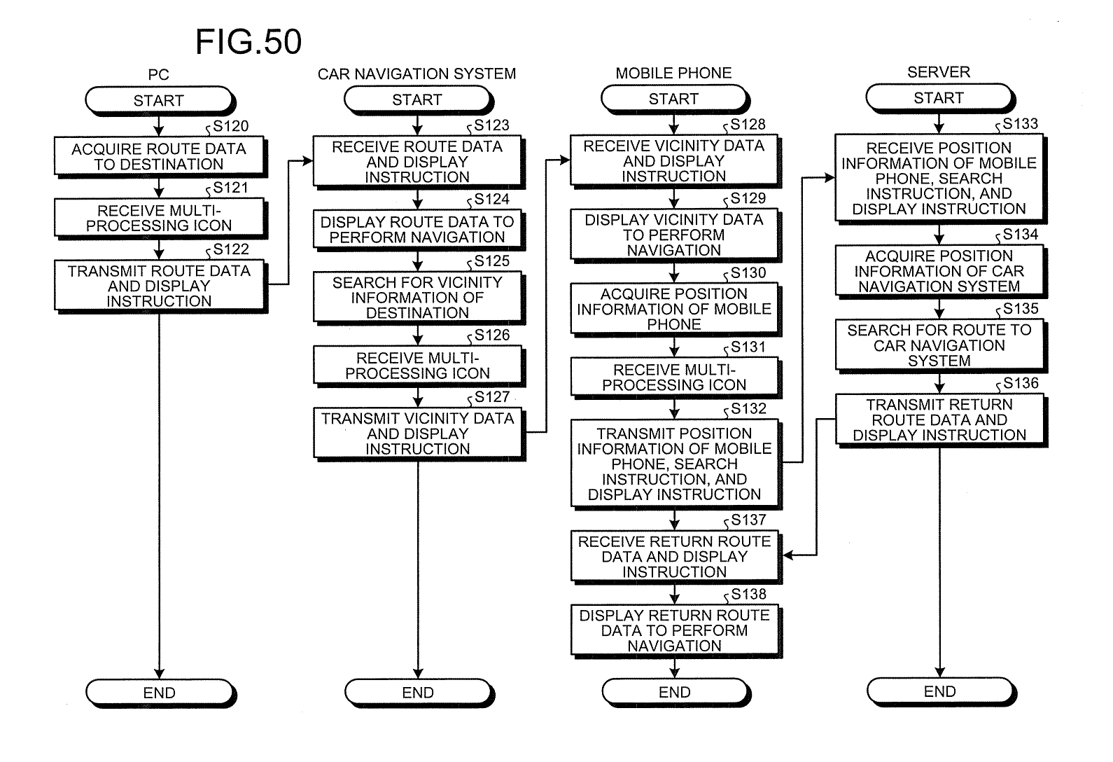

Anther display executing process performed by the PC 830, the car navigation system 850, the mobile phone 730, and the server 910 according to the fourth embodiment is explained next. FIG. 50 is a flowchart of an overall flow of another display executing process in the fourth embodiment. A process performed by the PC 830, the car navigation system 850, the mobile phone 730, and the server 910 is explained below, using the icon explained with reference to FIGS. 41, 43, and 47 as the multi-processing icon. The display process of the multi-processing icon by the PC 830 is controlled by the execution controller 810 in the following manner, and the display process of the multi-processing icon by the car navigation system 850 is controlled by the execution controller 864 in the following manner.

The process from acquisition of the route data by the route acquiring unit 818 in the PC 830 until display of the vicinity data by the display processing unit 714 in the mobile phone 730 and navigation performed by the navigation processing unit 719 (Steps S120 to S129) is the same as the process in FIG. 48 (Steps S80 to S89), and therefore explanations thereof will be omitted.

The position-information acquiring unit 720 in the mobile phone 730 acquires the position information of the mobile phone 730 (Step S130). The input receiving unit 715 receives the multi-processing icon including the return-route search icon image and the return route display icon image (see FIG. 47) from the user (Step S131).

Upon reception of the multi-processing icon, the transmitting and receiving unit 716 transmits the position information of the mobile phone 730, a search instruction for searching for the return route data from the mobile phone 730 to the car navigation system 850, and a display instruction of the return route data to the server 910 (Step S132).

The server 910 receives the position information of the mobile phone 730, the search instruction of the return route data, and the display instruction of the return route data from the mobile phone 730 (Step S133). The server 910 acquires the position information of the car navigation system 850 (Step S134). The server 910 then searches for the return route from the mobile phone 730 to the car navigation system 850 based on the received search instruction and the position information of the mobile phone 730 and the car navigation system 850, to generate the return route data (Step S135). The server 910 transmits the searched return route data and the display instruction of the return route data to the mobile phone 730 (Step S136).

The transmitting and receiving unit 716 in the mobile phone 730 receives the return route data and the display instruction of the return route data from the server 910 (Step S137). The display processing unit 714 displays the return route data on the LCD 701, and the navigation processing unit 719 navigates the return route to the car navigation system 850 (return route to the car) based on the return route data displayed on the LCD 701 (Step S138).

Accordingly, in the PC 830, the car navigation system 850, and the mobile phone 730 according to the fourth embodiment, upon reception of the selection input of the multi-processing icon after acquiring the route data by the PC 830, the route data and the display instruction are transmitted to the car navigation system, and the car navigation system 850 displays the route data to perform a navigation process. Upon reception of the selection input of the multi-processing icon, the car navigation system 850 transmits the vicinity data obtained by searching around the destination to the mobile phone 730, and the mobile phone 730 displays the vicinity data to perform the navigation process. When the selection input of the multi-processing icon is received by the mobile phone 730, the return route data to the car searched by the mobile phone 730, the car navigation system 850, or the server 910 is displayed on the mobile phone 730 to perform the navigation process. Accordingly, processes in the different devices can be selected and performed simultaneously by receiving the selection input of the multi-processing icon concisely indicating a plurality of processing contents. Therefore, the operation procedure can be simplified, and the operability at the time of performing the processes simultaneously or in a row can be improved. Further, the processing contents to be executed can be easily ascertained by displaying the multi-processing icon including the input icon image corresponding to the input process and the output icon image corresponding to the output process on the monitor 801, the LCD monitor 851, or the LCD 701. By receiving the selection input of the processes by the multi-processing icon, an operational error can be prevented. Further, because the multi-processing can be easily performed between devices, data transfer is performed between the PC 830, the car navigation system 850, and the mobile phone 730, and necessary data can be easily displayed in the respective places.

In the fourth embodiment, the multi-processing icon including the processes to be performed by the PC, the car navigation system, and the mobile phone is displayed to perform the processes by the respective devices. However, in a fifth embodiment of the present invention, a multi-processing icon including the processes to be performed by an MFP, an in-vehicle MFP, and the car navigation system is displayed to perform the processes by the respective devices. The in-vehicle MFP is an MFP mounted on a movable vehicle or the like.

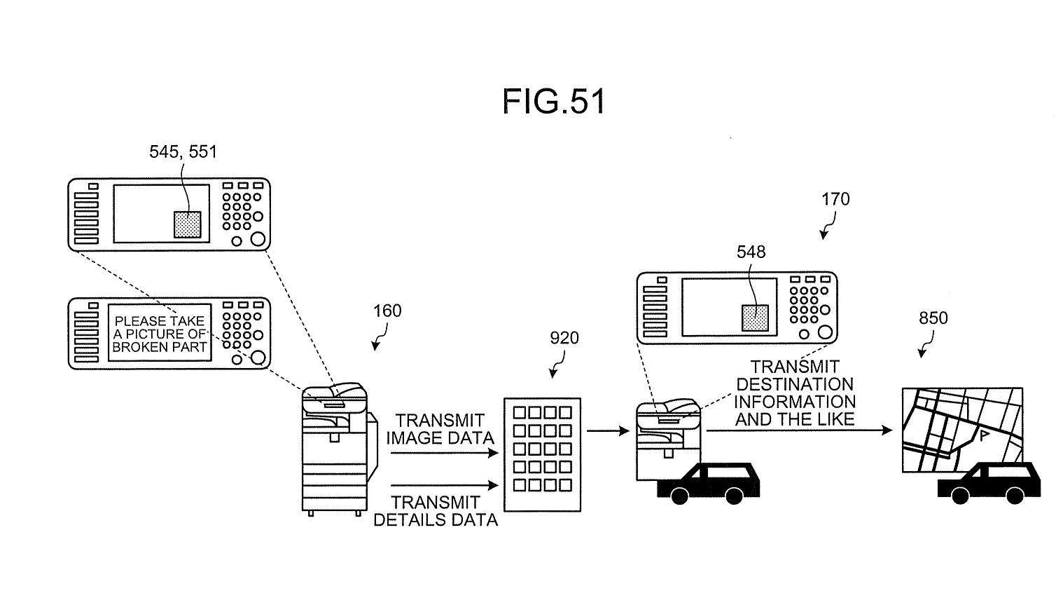

An outline of the process performed by the MFP, the in-vehicle MFP, and the car navigation system in the fifth embodiment is explained with reference to the accompanying drawings. FIG. 51 is a schematic diagram for explaining an outline of a process performed by the MFP, the in-vehicle MFP, and the car navigation system according to the fifth embodiment.

As shown in FIG. 51, in the fifth embodiment, when an MFP 160 has a malfunction, upon reception of a selection input of a multi-processing icon 545 (described later) from a user, the MFP 160 receives image data obtained by photographing a broken part by the user, and transmits the image data to a repair center 920 for repairing the MFP 160. When information such as a destination or the like (destination information) of the MFP 160 is input from the user (serviceman or the like) to an in-vehicle MFP 170 mounted on a car dispatched for repair, and the in-vehicle MFP 170 receives a selection input of a multi-processing icon 548 (described later) from the user, the in-vehicle MFP 170 transmits the destination information to the car navigation system 850, and the car navigation system 850 searches for a route to the destination, and displays the searched route data to perform navigation. When the MFP 160 has been repaired, upon reception of a selection input of a multi-processing icon 551 (described later) from the user, the MFP 160 scans a repair specification and transmits data of the repair specification (specification data) of the MFP 160 to the repair center 920.

In the process of the fifth embodiment, when the MFP or the like has a malfunction, an image obtained by photographing the broken part by the digital camera is transmitted the repair center so that the serviceman diagnoses the broken part. Further, the in-vehicle MFP is installed in the car of the serviceman, which searches for the information of the part (destination) of the troubled MFP or the like to transmit the searched information to the car navigation system. The car navigation system performs navigation to guide the serviceman to the destination. After the repair of the MFP, a repair report is prepared by scanning the repair specification and transmitted to the repair center.

Details of the MFP 160 are explained next. Because the configuration of the MFP 160 is the same as that of the MFP according to the first embodiment, only a configuration of a different function is explained with reference to FIG. 1.

The MFP 160 includes a scanner unit (not shown) that performs the scanning process according to an instruction from the scanner control 121. The scanner unit scans a document placed on the MFP 160, and for example, scans the repair specification of the repaired MFP 160.

The communication control 126 receives data and the like via the network, and for example, receives photographed data obtained by photographing the broken part of the MFP 160 from the digital camera. The input processing unit 111 inputs the received photographed data.

The communication control 126 transmits data and the like via the network, and transmits the received photographed data and the data of the repair specification (specification data) scanned by the scanner unit to the repair center.

The display processing unit 101 has a function of displaying a photographing instruction of the broken part, for example, guidance such as “please take a picture of broken part” on the LCD touch panel 220 when the MFP 160 has a malfunction, in addition to the function included in the first embodiment. The display processing unit 101 further displays the processing icon, the multi-processing icon, and the like on the LCD touch panel 220. The processing icon respectively corresponds to each of the processes (input process and output process) by the respective functions of the MFP 160, the in-vehicle MFP 170, and the car navigation system 850, for giving a selection instruction of the process by the respective functions. The multi-processing icon is an icon including a plurality of processing icon images for in a row performing the processes corresponding to the included respective processing icon images, upon reception of a selection instruction thereof from the user.

Specifically, for example, the display processing unit 101 displays, on the LCD touch panel 220, a multi-processing icon including an image of a reception icon (reception icon image) corresponding to a receiving process performed by the MFP 160 and an image of a transmission icon (transmission icon image) corresponding to the transmitting process performed by the MFP 160, for giving a selection instruction to perform the receiving process corresponding to the included reception icon image and the transmitting process corresponding to the included transmission icon image in a row.

Further, for example, the display processing unit 101 displays, on the LCD touch panel 220, a multi-processing icon including an image of a scanning icon (scanning icon image) corresponding to the scanning process performed by the MFP 160 and an image of the transmission icon (transmission icon image) corresponding to the transmitting process performed by the MFP 160, for giving a selection instruction to perform the scanning process corresponding to the included scanning icon image and the transmitting process corresponding to the included transmission icon image in a row.

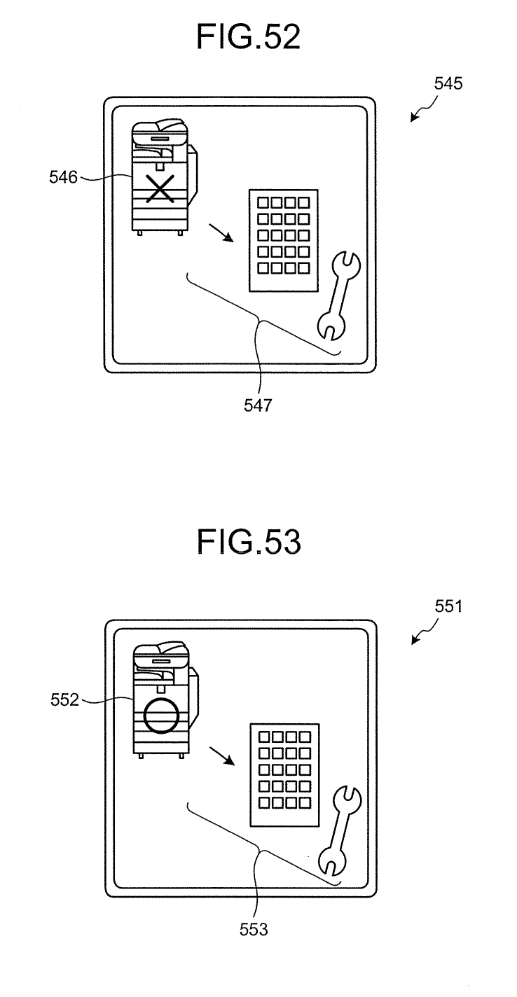

Details of the multi-processing icon displayed on the MFP according to the fifth embodiment are explained below. FIG. 52 is a schematic diagram for explaining one example of the configuration of the multi-processing icon displayed on the MFP. The multi-processing icon 545 is an icon including the reception icon image and the transmission icon image, for performing the receiving process of receiving image data obtained by photographing the broken part via the network from the digital camera or the like to the MFP 160 and the transmitting process of transmitting the image data from the MFP 160 to the repair center, upon reception of a selection instruction thereof from the user. As shown in FIG. 52, in the multi-processing icon 545, a processing icon 546 indicates the receiving process of the image data of the broken part of the MFP and a processing icon 547 indicates the transmitting process of the image data from the MFP to the repair center by the repair center and an arrow directed toward the repair center.

The MFP 160 holds the process correspondence table as in the first embodiment shown in FIG. 2 on a storage medium such as a memory, and registers the key event, icon name, and processing contents of a plurality of processes with respect to the multi-processing icon in FIG. 52. In the example of the multi-processing icons in FIG. 52, as the processing content corresponding to the multi-processing icons, an image data receiving process and the image data transmitting process are registered in the process correspondence table.

FIG. 53 is a schematic diagram for explaining another example of the multi-processing icon displayed on the MFP. The multi-processing icon 551 is an icon including the scanning icon image and the transmission icon image, for performing the scanning process of scanning the repair specification placed on the MFP 160 and the transmitting process of transmitting the specification data from the MFP 160 to the repair center, upon reception of a selection instruction thereof from the user. As shown in FIG. 53, in the multi-processing icon 551, a processing icon 552 indicates the scanning process of the repair specification of the MFP and a processing icon 553 indicates the transmitting process of the specification data from the MFP to the repair center by the repair center and an arrow directed toward the repair center.

In the example of the multi-processing icon in FIG. 53, as the processing content corresponding to the multi-processing icon, the scanning process and the image data transmitting process are registered in the process correspondence table.

Upon reception of the selection input of the multi-processing icon by the input receiving unit 103, the execution processing unit 105 controls the respective components to perform the process corresponding to the processing icon image included in the multi-processing icon. Specifically, for example, when the input receiving unit 103 receives a selection input of a multi-processing icon including the reception icon image and the transmission icon image (see FIG. 52), the execution processing unit 105 controls the receiving unit (the input processing unit 111) to receive (acquire) the image data obtained by photographing the broken part of the MFP 160 as the receiving process corresponding to the reception icon image included in the received multi-processing icon, and the transmitting unit (the output processing unit 112) to transmit the image data received by the receiving unit to the repair center, as the transmitting process corresponding to the transmission icon image included in the received multi-processing icon.

Further, for example, upon reception of the selection input of the multi-processing icon including the scanning icon image and the transmission icon image (see FIG. 53) by the input receiving unit 103, the execution processing unit 105 controls the scanner unit (the input processing unit 111) to scan the repair specification placed on the MFP 160 as the scanning process corresponding to the scanning icon image included in the received multi-processing icon, and the transmitting unit (the output processing unit 112) to transmit the specification data obtained by scanning the repair specification by the scanner unit to the repair center, as the transmitting process corresponding to the transmission icon image included in the received multi-processing icon.

Details of the in-vehicle MFP 170 are explained next. The in-vehicle MFP 170 has the same configuration as that of the MFP according to the first embodiment. Therefore, only a configuration of a different function is explained, with reference to FIG. 1. The in-vehicle MFP 170 is mounted on a movable car or the like, and is capable of printing a repair history and the like of a customer's MFP.

The input receiving unit 103 receives destination information, which is information of a user's (customer's) address (destination) who owns the MFP 160 having a malfunction, from the user (serviceman or the like who performs repair), and a selection input of the multi-processing icon.

The output processing unit 112 includes a transmitting unit (not shown) that performs processing by the communication control 126, and the transmitting unit transmits data and the like via the network, and for example, transmits route data to the MFP 160 searched by the in-vehicle MFP 170 to the car navigation system 850.

The display processing unit 101 has a function of displaying the processing icon and the multi-processing icon on the LCD touch panel 220, in addition to the function in the first embodiment. Specifically, for example, the display processing unit 101 displays, on the LCD touch panel 220, a multi-processing icon including an image of the transmission icon corresponding to the transmitting process performed by the in-vehicle MFP 170, and an image of the display icon image corresponding to the display process performed by the car navigation system 850, for giving a selection instruction to perform the transmitting process corresponding to the included transmission icon image and the display process corresponding to the included display icon image in a row.

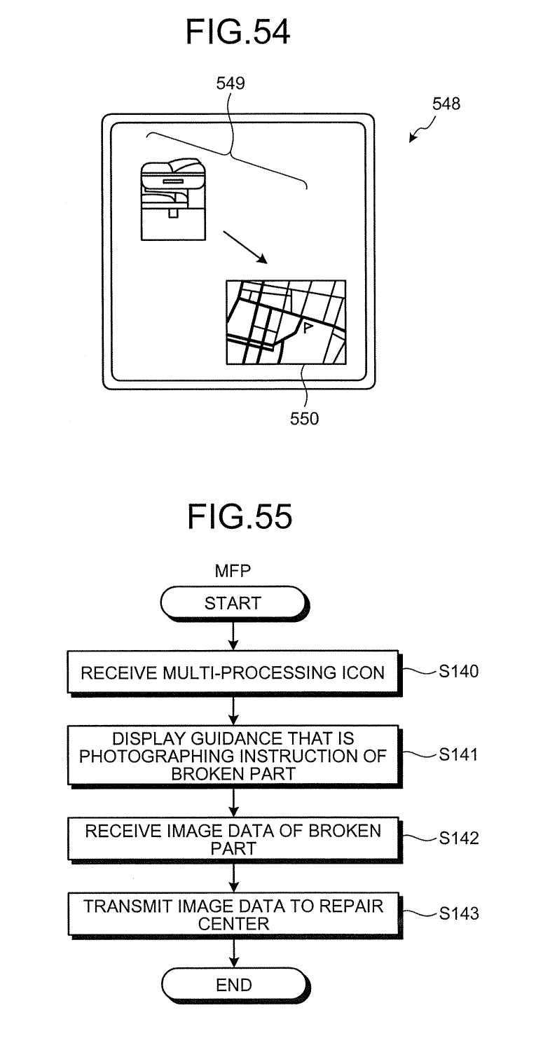

Details of the multi-processing icon displayed on the in-vehicle MFP according to the fifth embodiment are explained next. FIG. 54 is a schematic diagram for explaining one example of the configuration of the multi-processing icon displayed on the in-vehicle MFP. The multi-processing icon 548 is an icon including the transmission icon image and the display icon image, for performing the transmitting process of transmitting the destination information and a display instruction from the in-vehicle MFP 170 to the car navigation system 850, and the display process of displaying the route data to the destination by the car navigation system 850, upon reception of a selection instruction thereof from the user. As shown in FIG. 54, in the multi-processing icon 548, a processing icon 549 indicates the transmitting process of the destination information and the like by the in-vehicle MFP and an arrow directed toward the car navigation system, and a processing icon 550 indicates the display process of the route data to the destination by the car navigation system.

The in-vehicle MFP 170 holds the process correspondence table as in the first embodiment shown in FIG. 2 on a storage medium such as a memory, and registers the key event, icon name, and processing contents of a plurality of processes with respect to the multi-processing icon in FIG. 54. In the example of the multi-processing icons in FIG. 54, as the processing content corresponding to the multi-processing icon, the transmitting process and a display-instruction transmitting process are registered in the process correspondence table.

Upon reception of the selection input of the multi-processing icon by the input receiving unit 103, the execution processing unit 105 controls the respective components to perform the process corresponding to the processing icon image included in the multi-processing icon. Specifically, for example, when the input receiving unit 103 receives a specification input of the destination information and a selection input of a multi-processing icon including the transmission icon image and the display icon image (see FIG. 54), the execution processing unit 105 controls the transmitting unit (the output processing unit 112) to transmit the specified destination information and a display instruction for performing the display process corresponding to the display icon image to the car navigation system 850, as the transmitting process corresponding to the transmission icon image included in the received multi-processing icon.

Details of the car navigation system 850 are explained next. The car navigation system 850 has the same configuration as that of the car navigation system in the fourth embodiment. Therefore, only a configuration of a different function is explained, with reference to FIG. 42.

The transmitting and receiving unit 866 has a function of receiving the destination information specified by the user (serviceman) and the display instruction from the in-vehicle MFP 170, in addition to the function in the fourth embodiment.

The route search unit 865 has a function of generating the route data, upon reception of the destination information and the display instruction by the transmitting and receiving unit 866, by searching the route from the car navigation system 850 to the MFP 160 (destination), and storing the generated route data in the storage unit 870, in addition to the function in the fourth embodiment.

The display processing unit 861 has a function of displaying the route data searched by the route search unit 865 on the LCD monitor 851, in addition to the function in the fourth embodiment.

The display executing process by the MFP 160 thus configured in the fifth embodiment is explained. FIG. 55 is a flowchart of an overall flow of the display executing process in the fifth embodiment. The processing is performed below, using the icon explained in FIG. 52 as the multi-processing icon. The receiving process and the transmitting process of the multi-processing icon in the MFP 160 are controlled by the execution processing unit 105 in the following manner.

First, when the MFP 160 has a malfunction, the input receiving unit in the MFP 160 receives a multi-processing icon including the reception icon image and the transmission icon image (see FIG. 52) from the user (Step S140). The display processing unit 101 displays guidance of “please take a picture of broken part”, which is a photographing instruction of the broken part, on the LCD touch panel 220 (Step S141).

When the user images the broken part by the digital camera and transmits the imaged image data to the MFP 160, the receiving unit in the input processing unit 111 receives the image data of the broken part as the receiving process corresponding to the reception icon image included in the received multi-processing icon (Step S142). The transmitting unit in the output processing unit 112 transmits the received image data to the repair center where repair of the MFP 160 is performed, as the transmitting process corresponding to the transmission icon image included in the received multi-processing icon (Step S143).

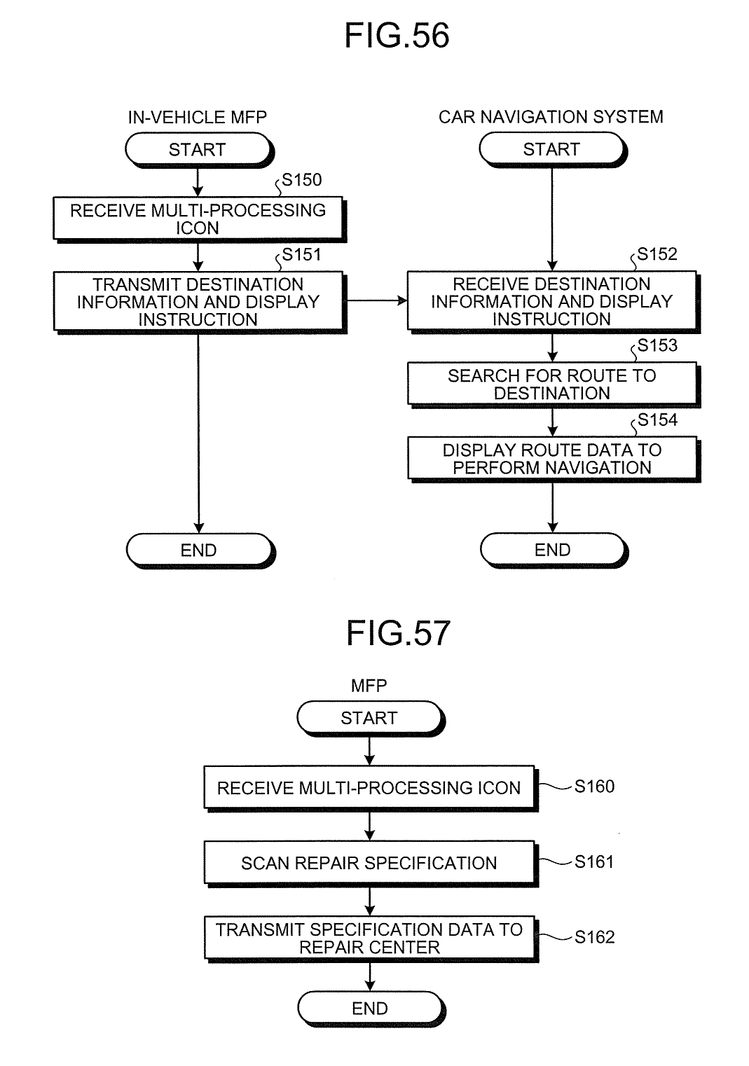

The display executing process performed by the in-vehicle MFP 170 and the car navigation system 850 in the fifth embodiment is explained below. FIG. 56 is a flowchart of an overall flow of the display executing process in the fifth embodiment. The processing is performed below, using the icon explained in FIG. 54 as the multi-processing icon. The receiving process and the transmitting process of the multi-processing icon in the in-vehicle MFP 170 are controlled by the execution processing unit 105 in the following manner.

First, the input receiving unit 103 receives the destination information, which is information of a user's (customer's) address (destination) who owns the MFP 160 having a malfunction, and a multi-processing icon including the transmission icon image and the display icon image (FIG. 54) from the user (serviceman or the like who performs repair) (Step S150). The transmitting unit in the output processing unit 112 transmits the destination information and a display instruction for performing the display process corresponding to the display icon image to the car navigation system 850, as the transmitting process corresponding to the transmission icon image included in the received multi-processing icon (Step S151).

The transmitting and receiving unit 866 in the car navigation system 850 receives the destination information and the display instruction from the in-vehicle MFP 170 (Step S152). Upon reception of the destination information and the display instruction by the transmitting and receiving unit 866, the route search unit 865 searches for the route from the car navigation system 850 to the MFP 160 based on the destination information, to generate the route data (Step S153). The display processing unit 861 displays the route data on the LCD monitor 851, and the navigation processing unit 867 performs navigation for the route to the destination, based on the route data displayed on the LCD monitor 851 (Step S154).

The display executing process performed by the MFP 160 according to the fifth embodiment is explained next. FIG. 57 is a flowchart of an overall flow of the display executing process in the fifth embodiment. The processing is performed below, using the icon explained in FIG. 53 as the multi-processing icon. The scanning process and the transmitting process of the multi-processing icon in the MFP 160 are controlled by the execution processing unit 105 in the following manner.

First, when repair of the MFP 160 has finished, the input receiving unit 103 in the MFP 160 receives a multi-processing icon including the scanning icon image and the transmission icon image (see FIG. 53) from the user (Step S160). The scanner unit in the input processing unit 111 scans the repair specification placed by the user (Step S161).

The transmitting unit in the output processing unit 112 transmits data of the scanned repair specification (specification data) to the repair center where repair of the MFP 160 is performed (Step S162).

Thus, in the MFP 160, the in-vehicle MFP 170, and the car navigation system 850 according to the fifth embodiment, upon reception of a selection input of the multi-processing icon by the MFP 160, the image data is received and transmitted to the repair center. Upon reception of the destination information and the selection input of the multi-processing icon, the in-vehicle MFP 170 transmits the destination information and a display instruction to the car navigation system 850, and searches for the route to the destination (the MFP 160) to generate and display the route data. After repair of the MFP 160 has finished, upon reception of a selection input of the multi-processing icon, the in-vehicle MFP 170 scans the repair specification and transmits the scanned repair specification to the repair center. A plurality of processes in the different devices can be selected and performed simultaneously by receiving the selection input of the multi-processing icon concisely indicating a plurality of processing contents. Therefore, the operation procedure can be simplified, and the operability at the time of performing the processes simultaneously or in a row can be improved. Further, the processing contents to be executed can be easily ascertained by displaying the multi-processing icon including the input icon image corresponding to the input process and the output icon image corresponding to the output process on the LCD touch panel 220. By receiving the selection input of the processes by the multi-processing icon, an operational error can be prevented. Further, because the multi-processing can be easily performed between devices, data required for repair of the MFP 160 can be easily acquired.

In the fifth embodiment, the image data of the broken part of the MFP 160 is received from the digital camera via the network to acquire the image data of the MFP 160. However, the image data can be acquired by using a memory card such as a secure digital memory card (SD card), which is a card-type storage device.

Further, in the second to fifth embodiments, the processes performed by respective devices by displaying the multi-processing icon have been explained. However, in the second to fifth embodiments, the multi-processing icon in which the processing icon images of performed processes are arranged can be generated as in the first embodiment. Generation of the multi-processing icon is the same as in the first embodiment, and therefore explanations thereof will be omitted.

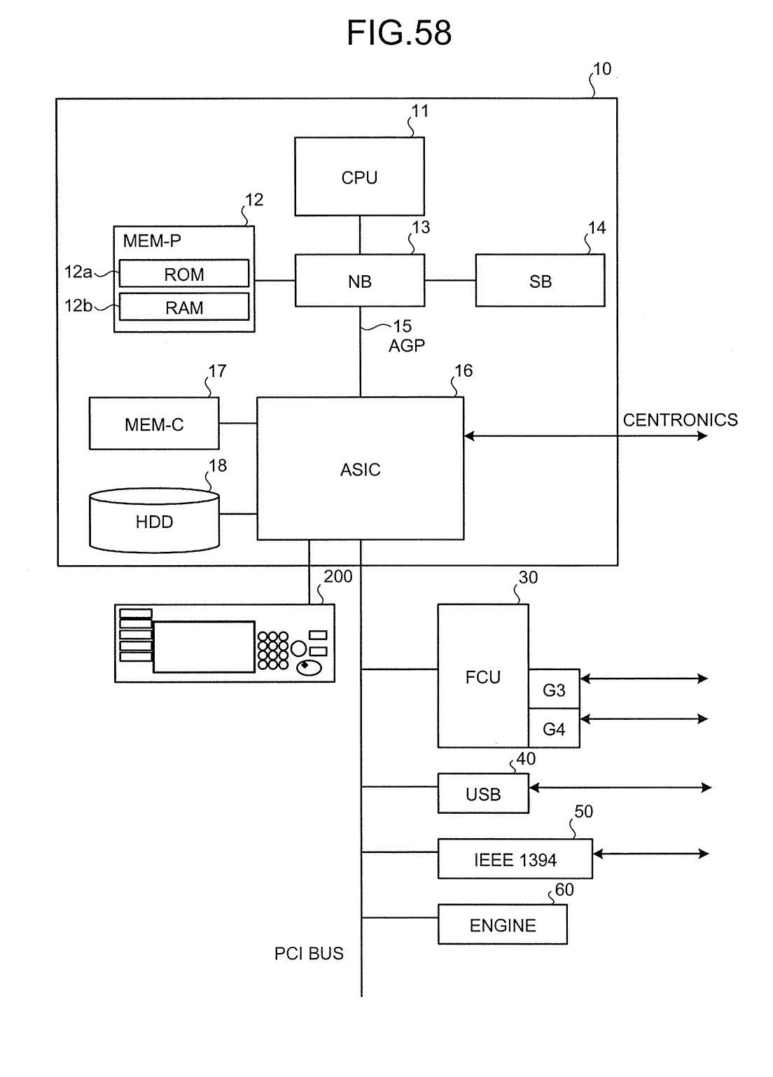

FIG. 58 is a block diagram of a hardware configuration common to the MFP 100 according to the first embodiment, the MFP 160 according to the second embodiment, and the in-vehicle MFP 170 according to the fifth embodiment. As shown in FIG. 58, the MFP 100, the MFP 160, and the in-vehicle MFP 170 have a configuration in which a controller 10 and an engine 60 are connected by a peripheral component interconnect (PCI) bus. The controller 10 performs overall control of the MFP 100, the MFP 160, and the in-vehicle MFP 170, drawing, communication, and an input from the operation unit (not shown). The engine 60 is a printer engine or the like connectable to the PCI bus, and for example, a monochrome plotter, 1-drum color plotter, 4-drum color plotter, scanner, or fax unit. The engine 60 includes an image processing part such as error diffusion and gamma transformation in addition to a so-called engine part such as the plotter.

The controller 10 further includes a CPU 11, a north bridge (NB) 13, a system memory (MEM-P) 12, a south bridge (SB) 14, a local memory (MEM-C) 17, an application specific integrated circuit (ASIC) 16, and an HDD 18, and the NB 13 and the ASIC 16 are connected by an accelerated graphics port (AGP) bus 15. The MEM-P 12 includes a ROM 12a and a random access memory (RAM) 12b.

The CPU 11 performs overall control of the MFP 100, the MFP 160, and the in-vehicle MFP 170, has a chip set including the NB 13, the MEM-P 12, and the SB 14, and is connected to other devices via the chip set.

The NB 13 is a bridge for connecting the CPU 11 with the MEM-P 12, the SB 14, and the AGP bus 15, and has a memory controller for controlling read and write with respect to the MEM-P 12, a PCI master, and an AGP target.

The MEM-P 12 is a system memory used as a storage memory for programs and data, a developing memory for programs and data, and a drawing memory for the printer, and includes the ROM 12a and the RAM 12b. The ROM 12a is a read only memory used as the storage memory for programs and data, and the RAM 12b is a writable and readable memory used as the developing memory for programs and data, and the drawing memory for the printer.

The SB 14 is a bridge for connecting between the NB 13, a PCI device, and a peripheral device. The SB 14 is connected to the NB 13 via the PCI bus, and a network interface (I/F) unit is also connected to the PCI bus.

The ASIC 16 is an integrated circuit for image processing application, having a hardware element for image processing, and has a role as a bridge for connecting the AGP bus 15, the PCI bus, the HDD 18, and the MEM-C 17, respectively. The ASIC 16 includes a PCI target and an AGP master, an arbiter (ARB) as a core of the ASIC 16, a memory controller for controlling the MEM-C 17, a plurality of direct memory access controllers (DMAC) that rotate the image data by a hardware logic, and a PCI unit that performs data transfer to/from the engine 60 via the PCI bus. To the ASIC 16 are connected a fax control unit (FCU) 30, a universal serial bus (USB) 40, an interface 50 of the IEEE 1394 via the PCI bus. The operation panel 200 is directly connected to the ASIC 16.

The MEM-C 17 is a local memory used as a copy image buffer and an encoding buffer. The HDD 18 is a storage for storing image data, programs, font data, and forms.

The AGP bus 15 is a bus interface for graphics accelerator card proposed for speeding up the graphic processing, and speeds up the graphics accelerator card by directly accessing the MEM-P 12 with high throughput.

A display processing program executed by the MFP and the in-vehicle MFP according to the first, second, and fifth embodiments is incorporated in the ROM or the like in advance and provided.

The display processing program executed by the MFP and the in-vehicle MFP according to the first, second, and fifth embodiments can be provided by being recorded on a computer readable recording medium such as a CD-ROM, flexible disk (FD), CD-R, or digital versatile disk (DVD) in an installable or executable format file.

The display processing program executed by the MFP and the in-vehicle MFP according to the first, second, and fifth embodiments can be stored on a computer connected to a network such as the Internet, and provided by downloading the program via the network. Further, the display processing program executed by the MFP and the in-vehicle MFP according to the first, second, and fifth embodiments can be provided or distributed via a network such as the Internet.

The display processing program executed by the MFP and the in-vehicle MFP according to the first, second, and fifth embodiments has a module configuration including the units described above (the display processing unit 101, the icon generating unit 102, the input receiving unit 103, the user authenticating unit 106, and the execution processing unit 105). As actual hardware, the respective units are loaded on a main memory by reading the display processing program from the ROM and executing the display processing program by the CPU (processor), so that the display processing unit 101, the icon generating unit 102, the input receiving unit 103, the user authenticating unit 106, and the execution processing unit 105 are generated on the main memory.

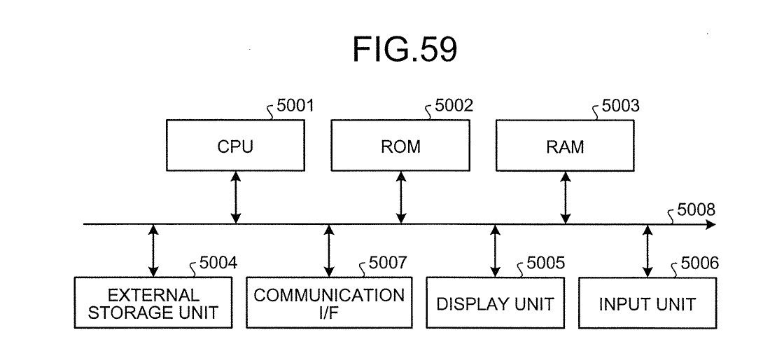

FIG. 59 depicts a hardware configuration of the PC 800 and the PC 830 according to the third and fourth embodiments. The PC 800 and the PC 830 according to the third and fourth embodiments respectively has a hardware configuration using a general computer, including a controller such as a CPU 5001, a storage unit such as a ROM 5002 and a RAM 5003, an HDD, an external storage unit 5004 such as a CD drive, a display unit 5005 such as a display, an input unit 5006 such as a keyboard and a mouse, a communication I/F 5007, and a bus 5008 for connecting these.

The display processing program executed by the PC 830 according to the fourth embodiment can be provided by being recorded on a computer readable recording medium such as a CD-ROM, FD, CD-R, or DVD in an installable or executable format file.

The display processing program executed by the PC 830 according to the fourth embodiment can be stored on a computer connected to a network such as the Internet, and provided by downloading the program via the network. Further, the display processing program executed by the PC 830 according to the fourth embodiment can be provided or distributed via a network such as the Internet.

Further, the display processing program executed by the PC 830 according to the fourth embodiment can be incorporated in a ROM or the like in advance and provided.

The display processing program executed by the PC 830 according to the fourth embodiment has a module configuration including the units described above (the display processing unit 816, the input receiving unit 817, the execution controller 810, the route acquiring unit 818, and the transmitting and receiving unit 819). As actual hardware, the respective units are loaded on a main memory by reading the display processing program from the storage medium and executing the display processing program by the CPU (processor), so that the display processing unit 816, the input receiving unit 817, the execution controller 810, the route acquiring unit 818, and the transmitting and receiving unit 819 are generated on the main memory.

FIGS. 60 to 66 are exterior views of the copying machine according to the above embodiments, where FIG. 60 is a perspective view of one example of the copying machine including an operation panel, FIG. 61 is a front view of one example of the copying machine including the operation panel, FIG. 62 is a back view of one example of the copying machine including the operation panel, FIG. 63 is a right side view of one example of the copying machine including the operation panel, FIG. 64 is a left side view of one example of the copying machine including the operation panel, FIG. 65 is a plan view of one example of the copying machine including the operation panel, and FIG. 66 is a bottom view of one example of the copying machine including the operation panel.

As described above, according to an aspect of the present invention, a plurality of operation procedures can be simplified by receiving a selection input of a plurality of processes by using a symbol concisely displaying a plurality of processing contents, and the operability at the time of performing the processes simultaneously or in a row can be improved. Further, the processing contents can be easily ascertained by displaying the symbol concisely displaying the processing contents. By receiving the selection input of the processes by the symbol, an operational error can be prevented. Further, according to the present invention, a plurality of processes can be performed easily in a plurality of different devices.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An apparatus for processing a display, comprising:
a display processing unit that displays on a display unit a multi-processing symbol including a first processing symbol corresponding to a first process and a second processing symbol corresponding to a second process that is different from the first process from among a plurality of processes, the multi-processing symbol for giving a selection instruction to perform the first process and the second process simultaneously or in a row;
an input receiving unit that receives a selection input of the multi-processing symbol from a user; and
an execution controller that performs, upon reception of the multi-processing symbol by the input receiving unit, simultaneously or in a row the first process corresponding to the first processing symbol included in a received multi-processing symbol and the second process corresponding to the second processing symbol included in the received multi-processing symbol.

2. The apparatus according to claim 1, wherein
the processes include an input process and an output process,
the first processing symbol is an input symbol corresponding to the input process, and
the second processing symbol is an output symbol corresponding to the output process.

3. The apparatus according to claim 1, wherein
the display processing unit displays on the display unit the multi-processing symbol further including at least one other processing symbol corresponding to other process different from the first process and the second process from among the processes, the multi-processing symbol for giving a selection instruction to perform the first process, the second process, and the at least one other process simultaneously or in a row, and
upon reception of the multi-processing symbol by the input receiving unit, the execution controller performs simultaneously or in a row the first process corresponding to the first processing symbol included in the received multi-processing symbol, the second process corresponding to the second processing symbol included in the received multi-processing symbol, and the other process corresponding to the at least one other processing symbol included in the received multi-processing symbol.

4. The apparatus according to claim 1, wherein the multi-processing symbol further includes a relation symbol indicating a processing relation corresponding to each processing symbol.

5. The apparatus according to claim 2, wherein the multi-processing symbol further includes a relation symbol indicating a processing relation corresponding to each processing symbol.

6. The apparatus according to claim 3, wherein the multi-processing symbol further includes a relation symbol indicating a processing relation corresponding to each processing symbol.

7. The apparatus according to claim 4, further comprising a storage unit that stores therein a process correspondence table in which symbol identification information specific to the multi-processing symbol and process identification information of processes to be performed simultaneously or in a row are registered in association with each other, wherein
upon reception of the multi-processing symbol by the input receiving unit, the execution controller refers to the process correspondence table, to perform a plurality of processes indicated by a plurality of pieces of process identification information corresponding to the symbol identification information in the received multi-processing symbol simultaneously or in a row.

8. The apparatus according to claim 5, further comprising a storage unit that stores therein a process correspondence table in which symbol identification information specific to the multi-processing symbol and process identification information of processes to be performed simultaneously or in a row are registered in association with each other, wherein
upon reception of the multi-processing symbol by the input receiving unit, the execution controller refers to the process correspondence table, to perform a plurality of processes indicated by a plurality of pieces of process identification information corresponding to the symbol identification information in the received multi-processing symbol simultaneously or in a row.

9. The apparatus according to claim 6, further comprising a storage unit that stores therein a process correspondence table in which symbol identification information specific to the multi-processing symbol and process identification information of processes to be performed simultaneously or in a row are registered in association with each other, wherein
upon reception of the multi-processing symbol by the input receiving unit, the execution controller refers to the process correspondence table, to perform a plurality of processes indicated by a plurality of pieces of process identification information corresponding to the symbol identification information in the received multi-processing symbol simultaneously or in a row.

10. The apparatus according to claim 1, wherein
the display processing unit displays a plurality of processing symbols respectively corresponding to a plurality of predetermined processes on the display unit,
the input receiving unit receives a selection input of the processing symbols, and
the apparatus further comprises a symbol generating unit that generates the multi-processing symbol including a plurality of received processing symbols.

11. The apparatus according to claim 10, wherein when the processes are performed by the execution controller, the symbol generating unit generates the multi-processing symbol including the processing symbols corresponding to performed processes.

12. The apparatus according to claim 11, wherein
the processes include an input process and an output process,
the first processing symbol is an input symbol corresponding to the input process,
the second processing symbol is an output symbol corresponding to the output process, and
when the execution processor performs the input process and the output process, the symbol generating unit generates the multi-processing symbol including the input symbol and the output symbol.

13. The apparatus according to claim 12, further comprising a storage unit that stores therein a process correspondence table in which symbol identification information specific to the multi-processing symbols is associated with process identification information of the processes to be performed simultaneously or in a row, and the symbol identification information of each of the processing symbols is associated with the process identification information of each of the processes to be performed, wherein
the symbol generating unit refers to the process correspondence table to read out the processing symbols corresponding to the symbol identification information corresponding to the received processing symbols from the storage unit, generates a multi-processing symbol including read processing symbols, stores the generated multi-processing symbol in the storage unit, and registers the symbol identification information corresponding to a generated multi-processing symbol and the process identification information of the processes in the process correspondence table in association with each other.

14. A method of processing a display, comprising:
displaying on a display unit a multi-processing symbol including a first processing symbol corresponding to a first process and a second processing symbol corresponding to a second process that is different from the first process from among a plurality of processes, the multi-processing symbol for giving a selection instruction to perform the first process and the second process simultaneously or in a row;
receiving a selection input of the multi-processing symbol from a user; and
performing, upon reception of the multi-processing symbol at the receiving, simultaneously or in a row the first process corresponding to the first processing symbol included in a received multi-processing symbol and the second process corresponding to the second processing symbol included in the received multi-processing symbol.

15. A computer program product comprising a computer-usable medium having computer-readable program codes embodied in the medium that when executed cause a computer to execute:
displaying on a display unit a multi-processing symbol including a first processing symbol corresponding to a first process and a second processing symbol corresponding to a second process that is different from the first process from among a plurality of processes, the multi-processing symbol for giving a selection instruction to perform the first process and the second process simultaneously or in a row;
receiving a selection input of the multi-processing symbol from a user; and
performing, upon reception of the multi-processing symbol at the receiving, simultaneously or in a row the first process corresponding to the first processing symbol included in a received multi-processing symbol and the second process corresponding to the second processing symbol included in the received multi-processing symbol.
